(19) United States
(12) Patent Application Publication
(10) Pub. No.: US 2025/0230700 A1
(43) Pub. Date: Jul. 17, 2025

(54) Smart Safe and System for Managing Smart Safes

(71) Applicant: Oh Baby LLC dba Space, Tinton Falls, NJ (US)

(72) Inventor: Oscar Hedaya, Tinton Falls, NJ (US)

(73) Assignee: Oh Baby LLC dba Space, Tinton Falls, NJ (US)

(21) Appl. No.: 19/033,070

(22) Filed: Jan. 21, 2025

Related U.S. Application Data
(60) Provisional application No. 63/621,733, filed on Jan. 17, 2024.

(51) Int. Cl. E05G 1/10; G07C 9/00

(52) U.S. Cl. CPC E05G 1/10; G07C 9/00563; G07C 9/00912

(57) ABSTRACT

A safe includes compartment assembly defining a safe volume, a door assembly coupled to a front of the compartment assembly, a computing system, and a sensor connected to the computing device that measures safe-related events. The computing system is configured to receive sensor data from the sensor and transmit the sensor data to a safe management system remote from the safe. The computing system is also configured to transmit supplemental sensor data to the safe management system in response to a request for supplemental sensor data received from the safe management system following receipt of a checkout indicator for an accommodation at the safe management system.

### CROSS-REFERENCE TO RELATED APPLICATIONS

The present patent application claims the priority benefit of U.S. Provisional Patent Application 63/621,733 filed Jan. 17, 2024, which is incorporated herein by reference in its entirety.

### BACKGROUND

Safes are a common tool for securing valuable items. In general, a safe consists of a body defining an inner cavity that is accessible through a lockable hatch or door. Conventional safes often rely on mechanical (e.g., a key-based mechanism or rotary combination mechanism) or simple electromechanical (e.g., a digital keypad or fingerprint sensor and associated solenoid-driven locking mechanisms) systems to control locking and access to the safe. More recent developments in safe technologies have resulted in safes that permit communication with smart phones and other computing devices and systems, such as those for remote monitoring. Nevertheless, even modern “smart” safes remain relatively rudimentary, generally limited to basic monitoring and functions. With this in mind, the present disclosure is directed to advanced safes and a corresponding system for monitoring safes, managing safe operations, and collecting, analyzing, and leveraging safe-related data for a range of business and personal applications.

### BRIEF DESCRIPTION OF THE DRAWINGS

FIG. 1 to FIG. 9 are various views of a safe and its components according to an embodiment of the present disclosure.

FIG. 10 is a block diagram illustrating computing components of a safe according to the present disclosure.

FIG. 11A and FIG. 11B illustrates a computing environment including safes and a safe management system according to the present disclosure.

FIG. 12 illustrates a hierarchy and logical grouping for safes according to the present disclosure.

FIG. 13 is a block diagram of a safe management system according to the present disclosure.

FIG. 14 is a flow chart illustrating a method for determining the presence of items left in a safe.

FIG. 15 is a block diagram illustrating an example computing system.

FIGS. 16A-16E illustrate an example embodiment of the present disclosure having a locker-style form factor.

FIG. 17 illustrates an example embodiment of the present disclosure having a small and optionally portable form factor.

FIGS. 18A-G illustrate another example embodiment of the present disclosure having a form factor similar to that of the safe illustrated in FIGS. 1-9 but with different features and aesthetic elements.

### DETAILED DESCRIPTION

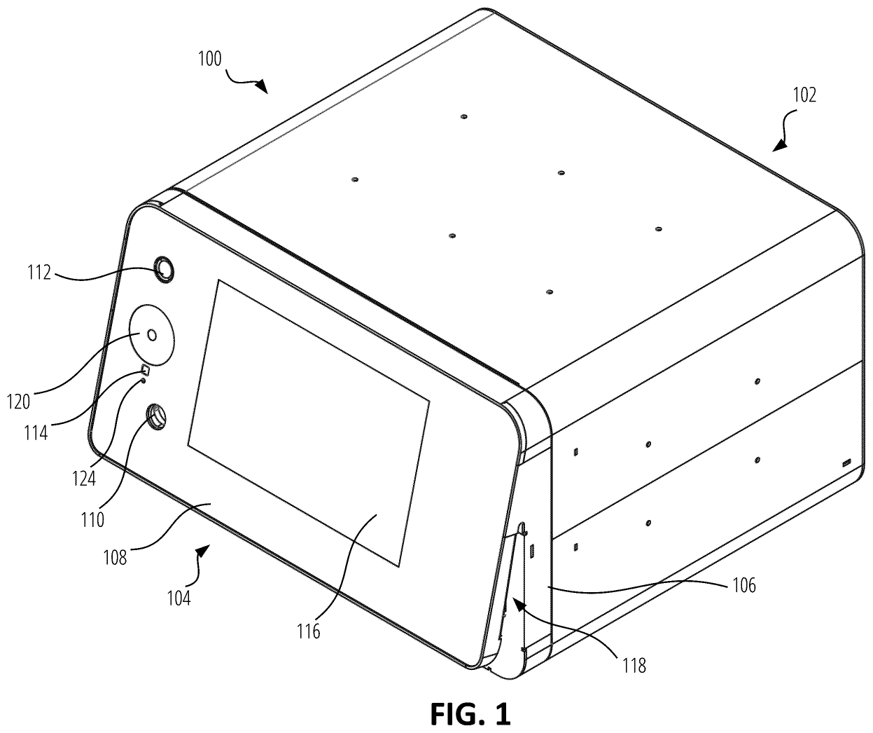

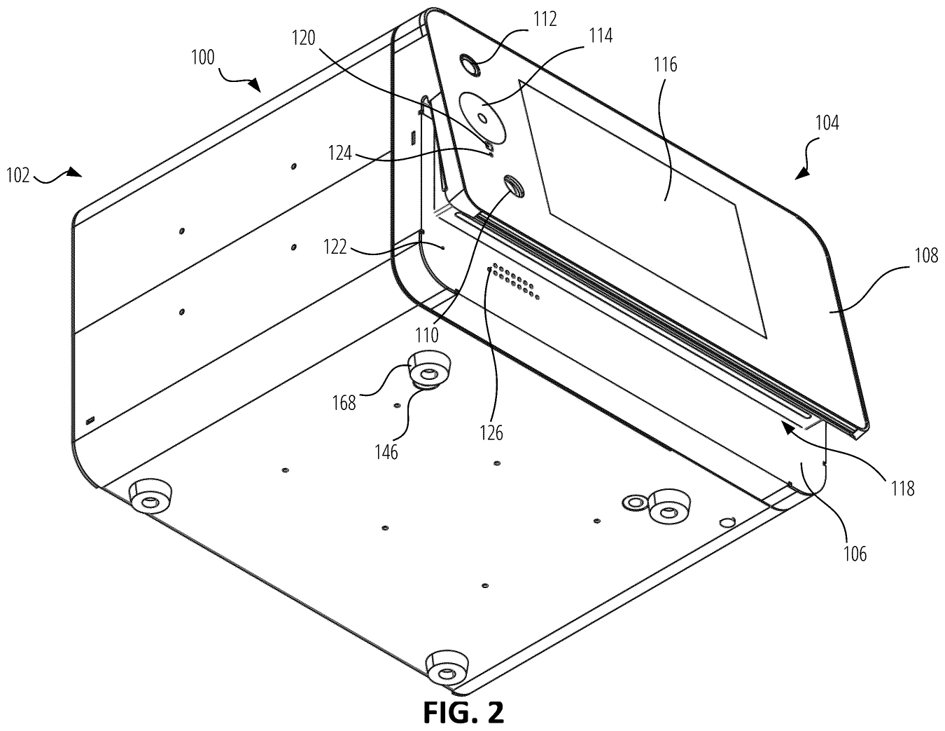

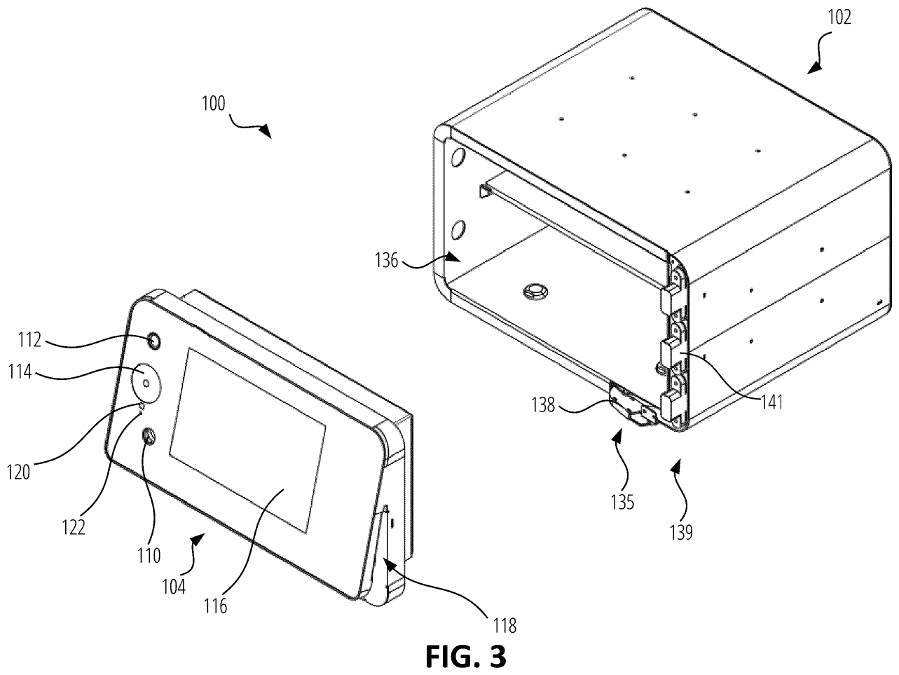

FIG. 1 to FIG. 9 illustrate a safe 100 according to an implementation of the present disclosure. FIG. 1 provides a top isometric view of safe 100 while FIG. 2 and FIG. 3 provide a bottom isometric and partially exploded view of safe 100, respectively.

In general, safe 100 is divided into a body assembly 102 and a door assembly 104. Door assembly 104 is coupled to body assembly 102 and movable relative to body assembly 102 to provide access to a safe volume 136 (indicated, e.g., in FIG. 3). Door assembly 104 is lockable and, when locked, prevents access to safe volume 136.

Door assembly 104 generally includes a door body 106 shaped to mate with and be partially received within body assembly 102 and a front panel 108. The figures illustrated front panel 108 as including various components such as a fingerprint reader 112, a key lock assembly 110, an external camera assembly 120, a microphone 122, and a speaker 126 (indicated in FIG. 2), each of which provides various functions and features of safe 100. The components of front panel 108 (including alternative and additional components) are discussed below in further detail.

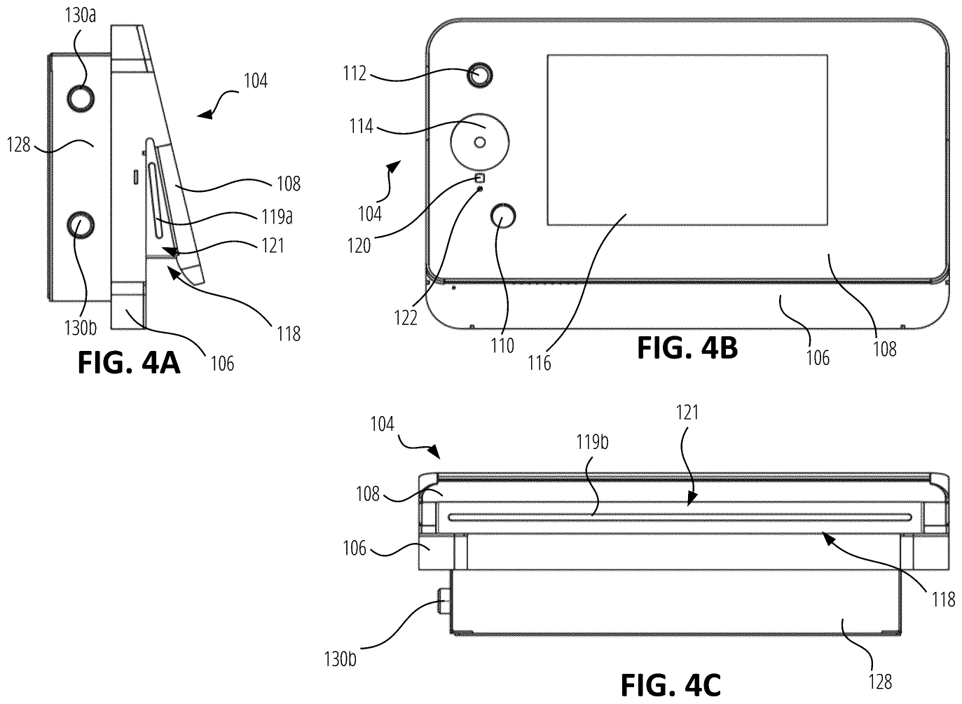

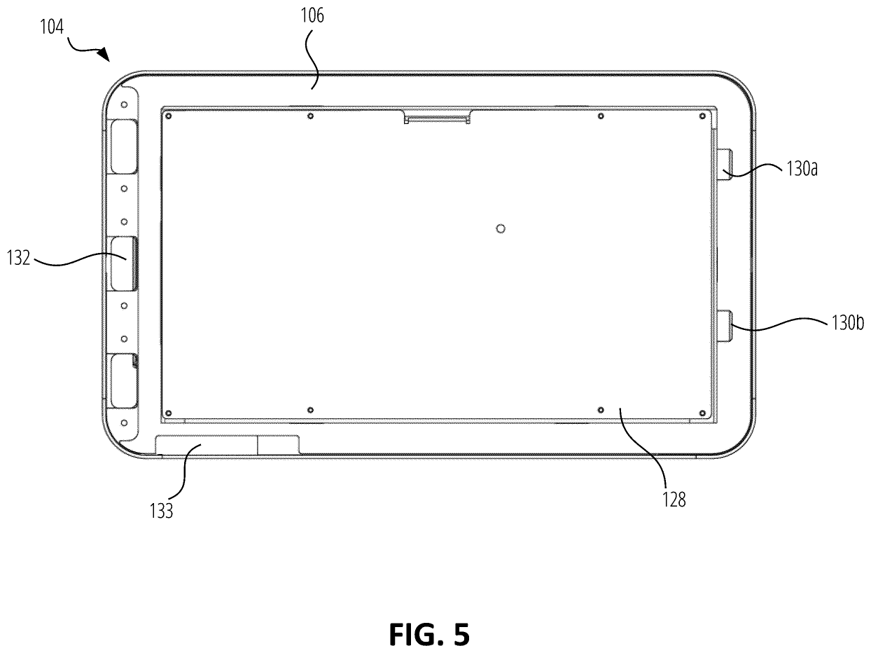

While not shown in the figures, door assembly 104 generally includes internal electromechanical and mechanical components to facilitate locking of door assembly 104 with body assembly 102. For example, in the illustrated example, door assembly 104 includes a backing plate 128 with internal actuators for translating each of locking bolt 130a and locking bolt 130b (shown, e.g., in FIG. 4A and FIG. 5) between an extended (i.e., locked) position and a retracted (i.e., unlocked) position.

As noted above, front panel 108 of door assembly 104 includes a touchscreen 116 for presenting a user interface to a user of safe 100. As described below in further detail, touchscreen 116 may be configured to provide a wide range of functions and features of safe 100. For example, in certain implementations, the user interface may include functionality for locally accessing safe 100, e.g., by enabling a user to provide a code or input. However, touchscreen 116 may also provide functionality directed to configuring safe 100 (e.g., managing users of safe 100), presenting multimedia content (e.g., videos, guides, tutorials, etc., related to functionality or configuration of safe 100), and communicating with external parties (e.g., a property owner, hotel front desk, or technical support/helpdesk for safe 100). This disclosure contemplates that the user interface presented on touchscreen 116 of safe 100 (or user interfaces presented on computing devices in communication with safe 100) may support multiple languages or be otherwise localized.

Touchscreen 116 and user interfaces presented using touchscreen 116 enable safe 100 to be accessed and operated in a substantially move intuitive and user-friendly manner as compared to conventional safes and safe systems. For example, touchscreen 116 and interfaces presented on touchscreen 116 can provide enhanced feedback to user of safe 100 such as by providing more direct and clear feedback regarding if and when the user provides a correct access pin/code, the user's biometric information is accepted, and the like. In addition to such features related to accessing the safe, integration of touchscreen 116 and its corresponding computing components substantially broadens the features of safe 100 and possibilities for integration and interoperation of safe 100 with other computing devices and systems. Notably, the integration of a computing device also enables ongoing updates and modifications to safe 100 including the addition of new features and functionality and improvements or patching of existing features. Among other enhancements, integration of a computing device enables enhanced security for safe 100, such as by enabling encryption and multi-factor authentication (e.g., by enabling integration of authenticator-related software and/or communication with remote authentication platforms). Similarly, integration of a computing device enables establishment of multiple user profiles, varying permissions across profiles, multiple access modalities (including enhanced biometric-based access, such as facial recognition), over-the-air updates, and similar features and functionalities that are substantially more sophisticated than features of conventional safe systems.

In addition to functions and features related to operation of safe 100, this disclosure contemplates that integration of touchscreen 116 into safe 100 may provide auxiliary functionality for safe 100. For example, in one specific implementation, touchscreen 116 may be configured to present advertisements to users. In one specific example, a hotel may user touchscreen 116 to advertise various amenities, specials, etc., within or associated with the hotel. As another example, safe 100 may be configured to present advertisements from local retailers and service providers. In response to a user touching an advertisement presented on touchscreen 116, touchscreen 116 may open and present a webpage or similar content with additional information related to the advertisement. In certain cases, safe 100 may be configured to communicate with an advertising system, such as Google AdSense, to retrieve advertisement data, track advertisement access by users, manage payments to the owner/operator of safe 100, and the like.

While touchscreen 116 may provide one modality for unlocking and accessing safe 100, this disclosure contemplates that safe 100 may include multiple access/unlocking modalities. In implementations in which safe 100 supports one or more access modalities, safe 100 may be configured to require only one modality or multiple modalities before granting access to safe volume 136. For example, in addition to touchscreen 116, front panel 108 is shown in FIG. 1 as including each of a fingerprint reader 112 and a key lock assembly 110. In such implementations, safe 100 may be configured such that users of safe 100 are required to provide both a code via touchscreen 116 and a fingerprint via fingerprint reader 112 before gaining access to safe volume 136 with key lock assembly 110 providing an additional measure to access safe volume 136 without a passcode.

This disclosure contemplates that safe 100 may support any suitable way of locally or remotely authenticating a user and granting access to safe 100. For purposes of this disclosure, the term “local authentication” is intended to cover authentication methodologies involving direct interaction with safe 100. So, for example, local authentication can be performed by inputting a code into safe 100 (e.g., via touchscreen), providing a fingerprint to safe 100, or using a suitable key in key lock assembly 110. In contrast, the term “remote authentication” is intended to cover authentication methodologies involving indirect interaction with safe 100 and, in most cases, involves the use of a computing device capable of communicating with safe 100. For example, in certain implementations the computing device may be a smart phone or similar mobile computing device capable of wirelessly communicating with safe 100, e.g., via Bluetooth, Wi-Fi, or a similar wireless communication protocol. In such implementations, the user may execute a safe-related application on the mobile computing device that performs authentication of the user for accessing safe 100. As another example, the computing device may be a hospitality management system for managing operation and accommodations for a hotel or similar facility. In such implementations, a hotel employee (e.g., a front desk or security employee) may have authority to remotely unlock a room safe via the hospitality management system on request from a guest and following verification of the guest's identity.

With regards to local authentication, this disclosure contemplates that safe 100 may include suitable components for implementing any suitable local authentication approach. For example, safe 100 may include components and software for locally authenticating users via one or more biometrics such as fingerprints (including authentication based on one or multiple fingerprints, partial or complete handprints, and the like), hand geometry, voice, ocular features (e.g., iris or retinal scanning), or facial features. Other non-limiting example forms of local authentication include keypads (e.g., keypads including numeric, alphanumeric, or symbolic keys), dials, keycard readers (or similar systems based on swiping, touching, or proximity of a card, dongle, or similar item), or a swipe or touch pad. Notably, local authentication techniques that rely on a user inputting a code or sequence may be provided through a physical component of safe 100 (e.g., a keypad) or may rely a representative/metaphorical form of the component in the user interface presented on touchscreen 116. So, for example, certain implementations of the present disclosure may include a physical numerical keypad while others may rely on a metaphorical keypad presented on touchscreen 116. Also, certain local authentication modalities may rely on other capabilities of the touchscreen 116. For example, safe 100 may be unlocked by a swipe pattern with certain implementations including a swipe or touch pad and other implementations relying on the touch and swipe detection capabilities of touchscreen 116.

In at least certain implementations, authentication may require a user to provide credentials using one or more authentication methods noted above. In addition to the various authentication methods noted above, safes according to this disclosure may also leverage their connectivity to rely on multi-factor authentication applications such as those provided by Google, Microsoft, Okta, RSA, etc.

This disclosure also contemplates that safe 100 may include a multi-step process for accessing safe 100 that first includes unlocking touchscreen 116. For example, touchscreen 116 may be in a locked, standby, or similar state that must be exited before a user is able to attempt to access safe 100 using touchscreen 116. So, for example, touchscreen 116 may present an image, blank screen, screen saver, or similar visualization when touchscreen 116 is locked. The user then interacts with touchscreen 116 in a particular way to unlock touchscreen 116, permitting the user to provide authentication for accessing the safe's contents. In certain implementations, unlocking touchscreen 116 may include simply touching touchscreen 116; however, the flexibility of touchscreen 116 may permit other, more secure methods for unlocking touchscreen 116. For example, unlocking touchscreen 116 may require a user to touch a specific area of touchscreen 116. Similarly, the user may be required to touch multiple areas on touchscreen 116 in a specific order or with a specific timing to unlock touchscreen 116. As another example, unlocking touchscreen 116 may require a user to provide a swipe pattern on touchscreen 116 in addition to or instead of a touch pattern. In still another example, touchscreen 116 may present a user with an interactive screen and unlocking touchscreen 116 may require the user to interact with elements of the interactive screen in a particular way to unlock the screen. For example, touchscreen 116 may present an aquarium animation including multiple fish with distinct characteristics (e.g., size, color, type, etc.) and unlocking touchscreen 116 may require the user to touch the fish in a specific order.

In at least certain implementations, configuration of safe 100 may include configuring an unlock methodology for touchscreen 116. For example, in certain implementations a user may select a specific methodology for unlocking touchscreen 116 and various parameters for the unlock methodology. Referring to the example of a user touching a specific area of touchscreen 116, configuration may include the user selecting an image/screen saver to present on touchscreen 116 and selecting the particular area of the image/screen saver that must be touched to unlock touchscreen 116. In certain implementations, a user may provide an image for use in unlocking touchscreen 116. Alternatively, safe 100 may come with various pre-installed images from which a user may choose that include various visual features (e.g., icons, numbers, symbols, etc.) amenable to use for unlocking touchscreen 116.

This disclosure also contemplates that safe 100 may support various forms of authentication recovery. For example, during initial access by a user, the user may be prompted to provide information for recovering or resetting a pin (or another authentication) of the user. Such information may include answers to one or more security questions, alternative contact information (e.g., an email address) to which a recovery link may be sent, and the like. Accordingly, a user may be given the option to recover a password, pin, etc., in a secure way in the event the user forgets his or her credentials.

This disclosure further contemplates that a user may configure a “panic” pin or similar code that initiates an emergency alert process. The emergency alert process may include, but is not limited to, transmitting a notification/alert to an owner or other designated user of the safe, transmitting an alert/notification to emergency services, and/or activating a local alarm system. While this disclosure contemplates that the user may configure his or her panic pin to be any suitable input to safe 100, in at least one specific implementation, a user's panic pin may be the reverse of the user's pin for accessing safe 100. So, for example, a user may use the pin 1-3-7-5-4 provided on a virtual keypad presented on touchscreen 116 to access safe 100 and the user's panic pin may default to 4-5-7-3-1.

Safes according to this disclosure may include integrated audio/video (A/V) components. For example, safe 100 is illustrated in FIG. 1 as including an external camera assembly 120, a microphone 122, and a speaker 126 (indicated in FIG. 2) in addition to touchscreen 116. In certain implementations, the A/V components may be used to enhance the user interface of safe 100 and/or to present multimedia content to a user (e.g., videos or interactive modules including instructions for setting up and configuring safe 100). In other implementations, the A/V components may enable various security-related features and functions of safe 100. For example, safe 100 may be configured to generate audio and/or visual alerts or alarms in response to tampering or failed access attempts.

As yet another example, external camera assembly 120 and microphone 122 may be configured to record or live stream audio and/or video in response to detecting certain events, such as tampering or failed access attempts. For example, in response to multiple failed access attempts (e.g., incorrect code entries, unidentified fingerprints, etc.), external camera assembly 120 and microphone 122 may begin recording audio and video of an area in front of safe 100. As another example, in response to detecting tampering, safe 100 may transmit a notification to a safe owner or administrator including a link or control to access or otherwise open a live feed with the A/V components of safe 100.

In still other implementations, the A/V components of safe 100 may facilitate one-or two-way communication between safe 100 and a remote device, such as a telephone or network-connected computing device. As in the previous example of recording, safe 100 may be configured to initiate a live one-or two-way connection with an external device in response to failed access attempts or tampering. For example, safe 100 may open a one-or two-way connection with an owner of safe 100 or, in the case of a hotel or similar accommodations, security personnel or employees (e.g., a front desk). As another example, safe 100 may initiate a connection with local police, security services, or similar authorities.

As yet another example, the A/V components of safe 100 may be configured to open a live chat or similar streaming session to help a user. For example, safe 100 may enable connection to and initiation of a live communication session (either video or audio and video) with a front desk or concierge of a hotel to answer questions a user may have regarding the hotel or nearby area. As another example, the A/V components of safe 100 may be used to initiate a communication session with a technical support desk to answer technical questions a user may have regarding configuration or operation of a safe.

External camera assembly 120 may include a camera as well as supplemental components configured to facilitate image and video capture by the camera. For example, in certain implementations, external camera assembly 120 may include an array of infrared (IR) light emitting diodes (LEDs) to facilitate image/video capture in low light conditions. Other examples of components that may be included in external camera assembly 120 include, without limitation, light sensors to automatically adjust exposure of the camera and electromechanical or digital zoom components to adjust the field of view and depth of field of the camera. In implementations of safes including light sensors, such sensor may also be used to support additional functions including, but not limited to, adjusting the brightness of touchscreen 116 and/or lights of safe 100. Among other advantages, such dynamic and automatic adjustments can be useful in improving battery life of safe 100, reducing power consumed by safe 100 (and corresponding utility bill), and enhancing general visibility of touchscreen 116.

In addition to being responsive to unauthorized access attempts, safe 100 may be configured to initiate communication sessions in response to a command received at safe 100. For example, safe 100 may be configured to present a panic or similar emergency button that may be activated in the case of an emergency. As another example, safe 100 may include functionality to initiate a non-emergency communication session with the owner of the property associated with safe 100, a front desk (or other personnel), and the like. For example, safe 100 may include one or more of hard buttons or controls of a user interface presented on touchscreen 116 for initiating communication with a predefined outside party and using any suitable communication modality (e.g., text message, phone call, video call, etc.).

As shown in FIG. 1, front panel 108 may include a motion sensor 114. Motion sensor 114 may be configured to detect movement in front of safe 100. In response to detecting movement using motion sensor 114, safe 100 may be configured to engage various functions and features, such as video or image capture by external camera assembly 120, generation and transmission of messages or alerts to a remote user, and initiation of a communication session between a remote user and safe 100. In one non-limiting example, motion sensor 114 may be configured to detect movement at a distance (e.g., 30 feet) from safe 100 and to cause safe 100 to capture an image or begin recording audio and/or video automatically such that the image and/or recording captures activity before direct interaction with safe 100 (e.g., the subject of the recording touching touchscreen 116 or another input of safe 100).

FIG. 4A to FIG. 4C illustrate various additional views of door assembly 104. More specifically, FIG. 4A is a side view of door assembly 104, FIG. 4B is a front view of door assembly 104, and FIG. 4C is a bottom view of door assembly 104.

In addition to the previously discussed features and components, FIG. 4A more clearly illustrates backing plate 128 and each of locking bolt 130a and locking bolt 130b. As previously discussed, backing plate 128 may include actuators and other components configured to electromechanically drive locking bolt 130a and locking bolt 130b between locked and unlocked states. In at least certain implementations, each of locking bolt 130a and locking bolt 130b may be formed from a high strength and robust material, such as, but not limited to 4140 steel.

FIG. 4A also indicates external lighting system 118. In general, external lighting system 118 may provide functional and/or decorative lighting for safe 100. In at least certain implementations, external lighting system 118 may include one or more LED strips (such as LED strip 119a and LED strip 119b (shown in FIG. 4C) distributed along a recess 121 disposed between front panel 108 and door body 106. In at least certain implementations, external lighting system 118 is customizable and configurable by a user of safe 100. Among other things, configuration of external lighting system 118 may include selecting a color (or range of colors), a brightness, a pattern, programmed transitions, and the like for external lighting system 118. External lighting system 118 may also be configured to change in response to a state of safe 100. For example, in response to a user successfully opening safe 100, external lighting system 118 may illuminate green. As another example, external lighting system 118 may automatically illuminate red, pulsate, etc., in response to activation of an alert or alarm due to failed access attempts or detected tampering of safe 100.

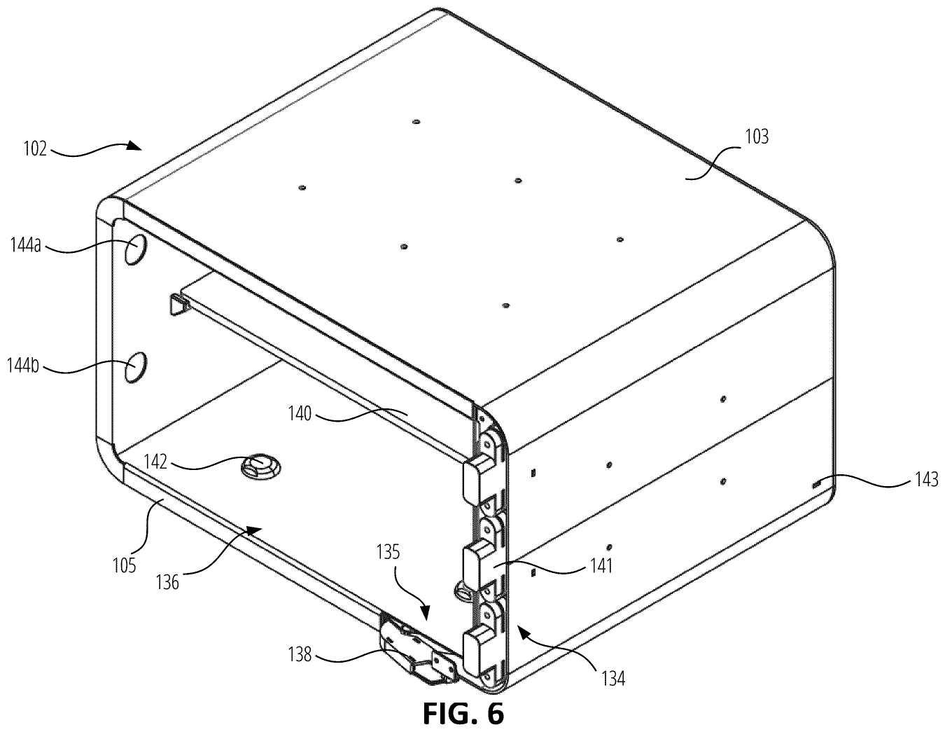

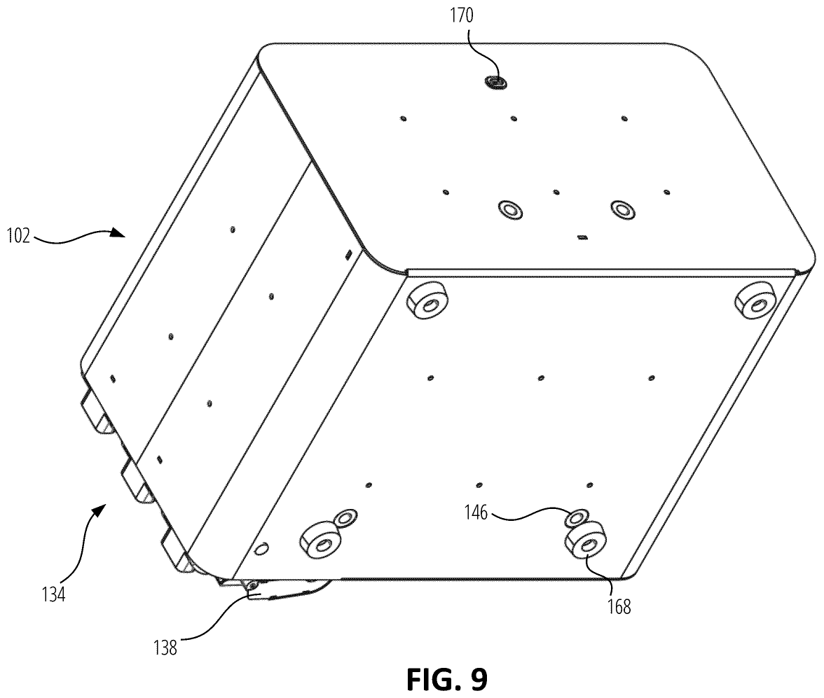

FIG. 5 is a rear view of door assembly 104. In addition to the previously discussed elements of door assembly 104, FIG. 5 more clearly illustrates features of door assembly 104 for coupling with body assembly 102 of safe 100. While this disclosure contemplates that other coupling arrangements may be used, the specific implementation illustrated in the figures includes a hinge assembly 139 (indicated, e.g., in FIG. 3, FIG. 6, and FIG. 9). Hinge assembly 139 couples body assembly 102 to door assembly 104 and permits opening of door assembly 104 relative to body assembly 102.

The specific configuration and arrangement of hinge assembly 139 may vary across implementations of this disclosure to accommodate different safe sizes, form factors, opening directions, and similar design considerations. Nevertheless, in certain implementations, hinge assembly 139 may include multiple pairs of hinge bodies and corresponding hinge recesses to provide additional support and security. For example, in the illustrated implementation, body assembly 102 includes three hinge bodies (e.g., hinge body 141, indicated in FIG. 3) which are received by corresponding hinge recesses (e.g., hinge recess 132, indicated in FIG. 5) of door assembly 104.

FIG. 6 is an isometric view of body assembly 102 of safe 100. Body assembly 102 generally includes a safe body 103 defining a safe volume 136. Actual dimensions and construction of safe body 103 may vary in implementations of this disclosure; however, in general, safe body 103 is formed from steel or another high strength material and has a construction designed to withstand a range of infiltration techniques and general damage to safe 100. For example, in certain implementations, safe body 103 may have a reinforced construction formed primarily from 9-gauge steel sheets formed into a substantially cubic shape defining an opening 105. Nevertheless, this disclosure contemplates that other steel thicknesses and other materials may be used in the construction of body assembly 102 and safe 100 more generally.

As shown in FIGS. 3 and 6, a conduit 138 may extend between body assembly 102 and door assembly 104 to facilitate routing of cables and wires between body assembly 102 and door assembly 104. In the specific example shown, conduit 138 is movable to accommodate opening of door assembly 104 relative to body assembly 102. To accommodate conduit 138, body assembly 102 includes a conduit pocket 135 within which conduit 138 is disposed. As door assembly 104 is opened and closed relative to body assembly 102, conduit 138 moves in and out of conduit pocket 135, thereby preventing conduit 138 from being pinched between or otherwise interfering with body assembly 102 and door assembly 104. While conduit 138 and conduit pocket 135 are shown in FIG. 6 as being disposed at a front, lower-righthand area of safe body 103, this disclosure contemplates that placement of conduit 138 and conduit pocket 135 may vary depending on preferences for how safe 100 is to be opened. For example, hinge assembly 139, conduit 138 and conduit pocket 135 may each be positioned and configured to enable door assembly 104 to open in any of a right-hand direction (as shown), a left-hand direction, upward, downward, etc.

As shown in FIG. 5, door assembly 104 may further include holes or similar receptacles for lock elements of door assembly 104. For example, body assembly 102 (as shown in FIG. 6) includes each of locking bolt hole 144a and locking bolt hole 144b for receiving locking bolt 130a and locking bolts 130b of door assembly 104 when door assembly 104 is closed and locked.

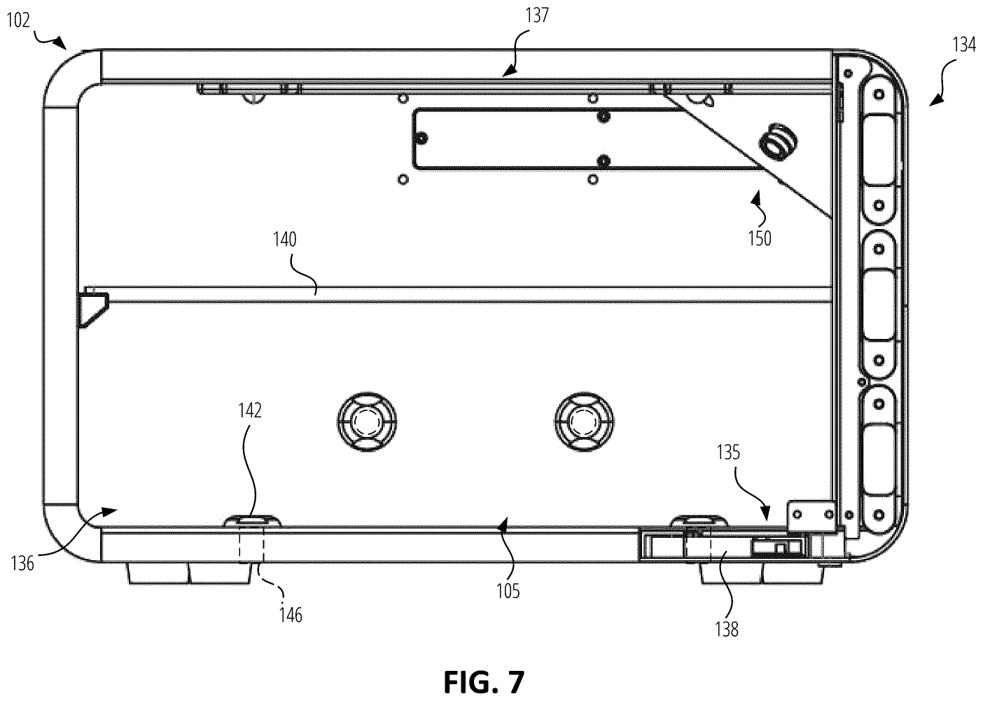

FIG. 6 also provides a partial view of a mounting system that may be part of safe 100. Specifically, FIG. 6 includes a fastener cap 142 disposed within body assembly 102 and intended to cover a head of a fastener for securing safe 100 to surrounding structures, such as furniture, walls, architectural features, etc. Referring to FIG. 7, for example, fastener cap 142 is illustrated as being disposed within safe body 103 and covering a mounting hole 146 (also shown in FIG. 9) through which a bolt or similar fastener may be extended to secure safe 100 to surrounding structures. In total, the figures illustrate body assembly 102 as including two downwardly extending mounting holes and corresponding fastener caps and two rearward extending mounting holes and corresponding fastener caps, any of which may be used to optionally secure safe 100 to surrounding structures. Other implementations may include more or fewer mounting holes and/or mounting holes disposed at other locations or on other sides of safe 100 to accommodate different mounting configurations.

Body assembly 102 may include various structural anti-theft features for further securing safe 100. For example, as shown in FIG. 6, body assembly 102 may include slots (e.g., slot 143) to which a corresponding lock device may be attached. By way of non-limiting example, slot 143 may be a female half of a Kensington lock or similar anti-theft system.

FIG. 7 is a front view of body assembly 102. In addition to the previously discussed elements of body assembly 102, FIG. 7 further illustrates a shelf 140 and an internal electronics assembly 150 disposed within body assembly 102. Shelf 140 is an optional structure intended to facilitate organization of safe contents. To the extent an implementation of this disclosure includes shelf 140, shelf 140 may be fixed within body assembly 102 or may be removable, e.g., by lifting and pulling shelf 140 through opening 105.

In at least certain implementations, shelf 140 may be formed from a transparent material, such as, but not limited to glass or acrylic. Among other advantages, a transparent material allows an internal camera assembly (e.g., internal camera assembly 154, discussed below in further detail) to have a substantially complete view of safe volume 136 while still allowing a user to organize and separate contents of safe 100.

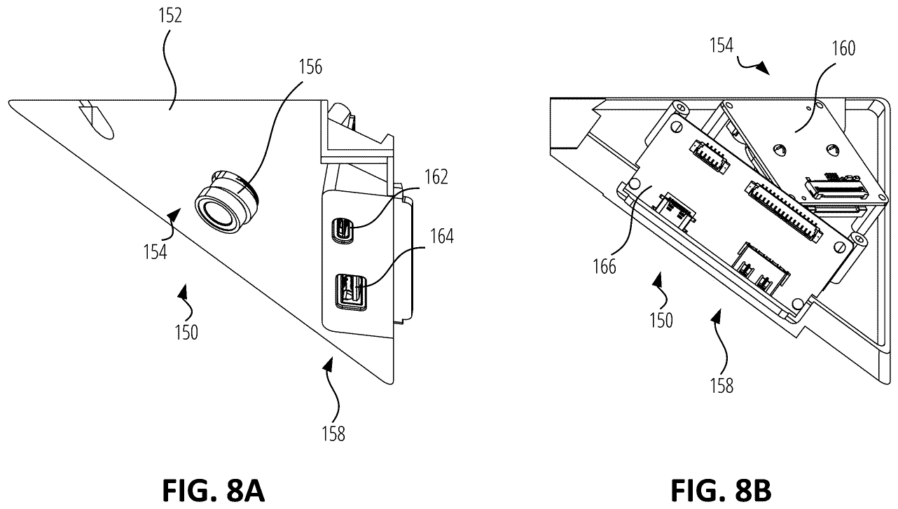

Internal electronics assembly 150 includes various internal electronic components for providing additional security features and functionality to safe 100. Internal electronics assembly 150 is illustrated in further detail in FIG. 8A and FIG. 8B, which are front and rear isometric views of 150, respectively.

While the specific components of internal electronics assembly 150 may vary, the implementation illustrated in the figures includes each of an internal camera assembly 154 and an internal port assembly 158 coupled to and extending through and coupled to a faceplate 152. In certain implementations, faceplate 152 is configured to both protect and conceal internal electronics assembly 150 and, in particular internal camera assembly 154. For example, faceplate 152 may be formed from a one-way transparent material to obscure internal camera assembly 154 or may be formed from a high-strength steel or otherwise mounted within safe volume 136 to prevent tampering or access to internal electronics assembly 150.

Internal camera assembly 154 generally includes an internal camera 156 configured and positioned to capture video and/or still images of safe volume 136. Internal camera assembly 154 may also be configured and positioned to capture video and images of opening 105, e.g., to capture the face and actions of an individual accessing safe volume 136.

Given that safe volume 136 is generally isolated from ambient light, internal camera assembly 154 may include components, such as infrared LEDs, to facilitate low-light vision and image/video capture. Alternatively, or in addition to such components, safe body 103 may be equipped with internal lights (e.g., LED strip 137, shown in FIG. 7) that may be activated in conjunction with capturing images or video with internal camera assembly 154.

As previously noted, internal electronics assembly 150 also includes internal port assembly 158. In one implementation, internal port assembly 158 includes one or more ports configured to connect to electronic devices that may be stored in safe 100 to enabling charging of stored devices. In certain implementations, one or more ports of internal port assembly 158 may also facilitate connection to and interaction between computing components of safe 100 and a computing device associated with an administrator, property owner, or user with similar authority. Among other functions, such connections may be used to perform diagnostics on safe 100, update firmware/software of safe 100, obtain data stored by safe 100 (e.g., activity logs), perform a factory reset, configure safe 100, and the like. Notably, in at least certain implementations, similar functions may be accessible by the user via the user interface presented on touchscreen 116 or by a remote/wireless connection to safe 100. Referring to the specific implementation shown in FIG. 8A and FIG. 8B, internal port assembly 158 includes a first port 162 and a second port 164 with first port 162 being a USB-C type port and second port 164 being a Type A USB port (e.g., a USB 2.0 or USB 3.0 type A port); however, this disclosure contemplates that internal port assembly 158, if included, may have any suitable number and type of ports.

FIG. 9 is an isometric bottom view of body assembly 102 illustrating an underside and rear surface of body assembly 102. As previously noted, body assemblies of safes according to the present disclosure may include various features to facilitate mounting and securing the safe to a separate structure. For example, FIG. 9 illustrates mounting holes (such as mounting hole 146) that extend through the wall of body assembly 102 into safe volume 136 and through which securing bolts may be extended. As illustrated, body assembly 102 includes two mounting holes on its underside and two on its rear; however, this disclosure contemplates that any suitable mounting features may be included in safes according to this disclosure.

FIG. 9 further illustrates the inclusion of supporting feet (e.g., foot 168) disposed on the bottom of body assembly 102. The supporting feet are intended to illustrate just one example of supporting structures that may be implemented in safes according to this disclosure. For example, in other implementations, the feet may be substituted with rails, pads, or similar structural elements that extend from an underside of body assembly 102. Among other things, the feet or other supporting structure may be configured to support safe 100 on the surface, to protect the underside of body assembly 102 and/or the surface, to dampen vibrations, and other similar functions. In at least certain implementations, the supporting features may also include integrated sensors or switches to detect movement or tampering of safe 100.

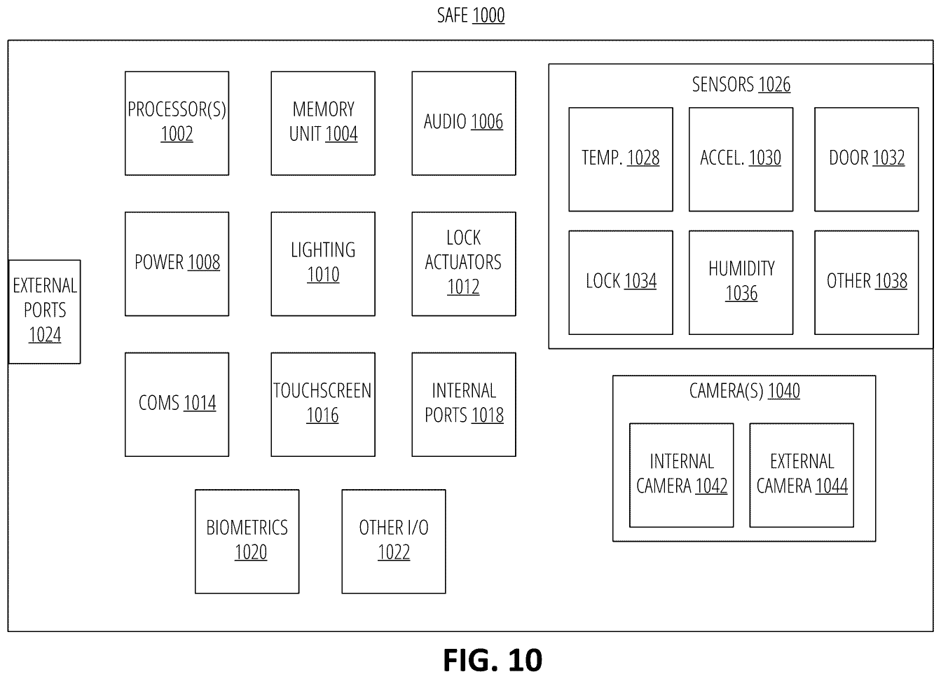

FIG. 10 is a block diagram of an example safe 1000 according to the present disclosure. More specifically, FIG. 10 illustrates the electrical and computing elements of safe 1000. Unless otherwise stated, safe 1000 may be, but is not necessarily limited to being mechanically and structurally similar to safe 100 discussed in the preceding section.

As shown, safe 1000 includes a processor 1002 and a memory unit 1004. Processor 1002 may correspond to one or more processors of any suitable type configured to execute instructions to perform the various functions and provide the various features of safe 1000. Such instructions may be stored, for example, in memory unit 1004, which, similar to processor 1002, may be any suitable type of computer memory on which instructions executable by processor 1002 may be stored. Additional functions and features of safe 1000 are discussed below with reference to the various components illustrated in FIG. 10. Generally speaking, and unless otherwise stated, processor 1002 controls and coordinates the general operation of safe 1000, including operation of the other components illustrated in FIG. 10.

As noted above, memory unit 1004 may take any suitable form. Memory unit 1004 may include one or more memory modules or elements configured to store instructions executable by processor 1002 or data related to safe 1000 and its operation. In at least certain implementations, memory unit 1004 may store user profile information and credentials for users of safe 1000. Such information may include personal information, contact information, authority/permissions, and the like. Memory unit 1004 may also store user credentials, such as user logins and passwords and biometric data. To the extent memory unit 1004 stores sensitive credentials or personal information, memory unit 1004 may be configured to encrypt or otherwise apply added layers of data protection to such information.

Memory unit 1004 may also store historical data and recordings generated by safe 1000. For example, memory unit 1004 may store an event log or similar file that records events related to operation of the safe. Such events may include, without limitation, opening/closing of safe 1000 is opened or closed, access attempts (including whether such attempts were successful or unsuccessful), tampering attempts, and the occurrence of any alert/alarm condition identified by safe 1000. The data collected and stored in memory unit 1004 may also include sensor measurements and sensor-related data corresponding to any of the sensors included in safe 1000. Memory unit 1004 may also be used to store images, video, audio, and similar recordings capture by the various recording systems of safe 1000.

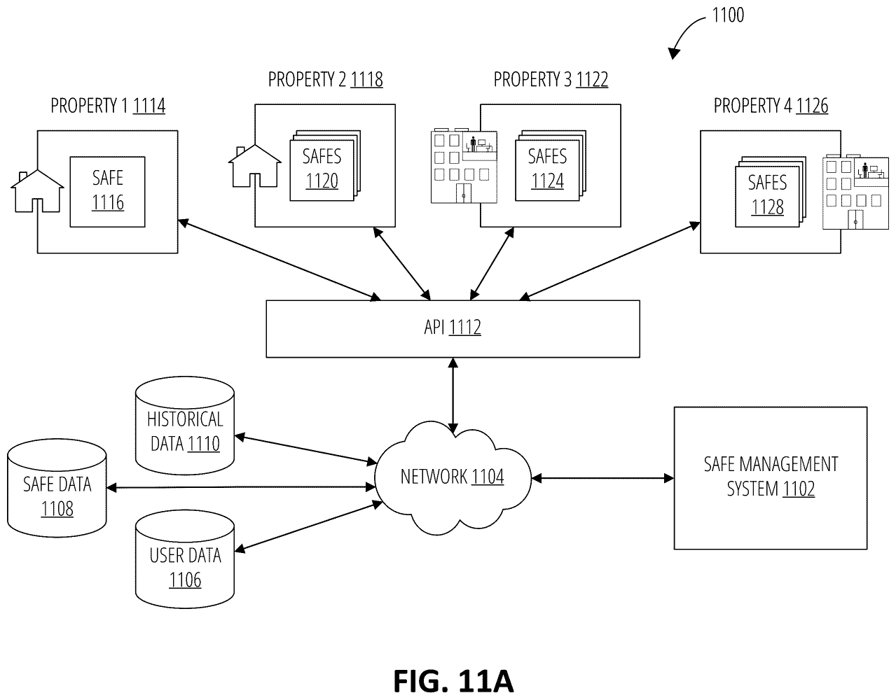

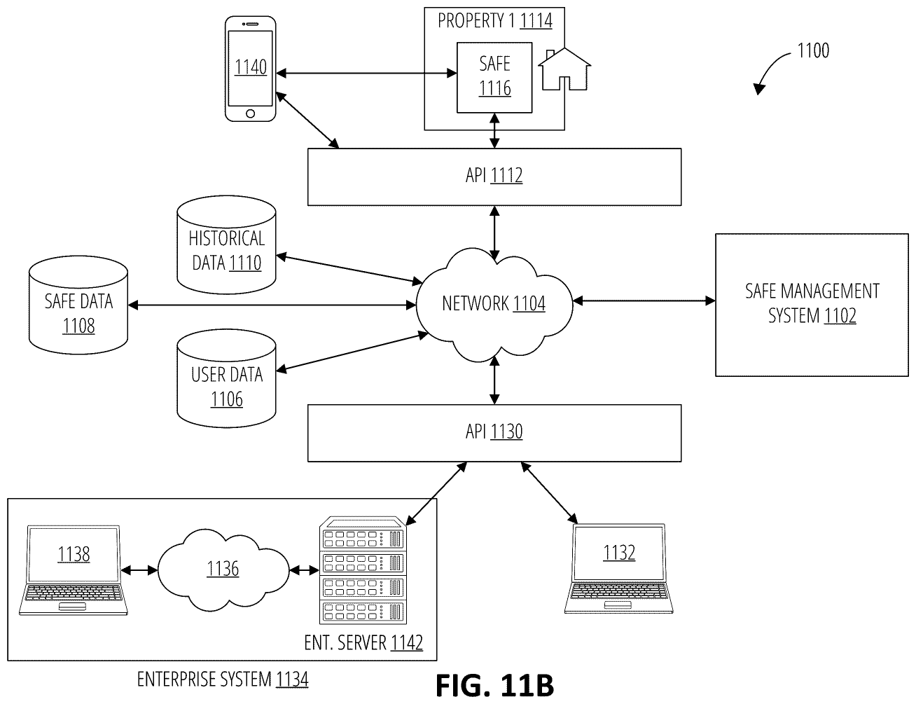

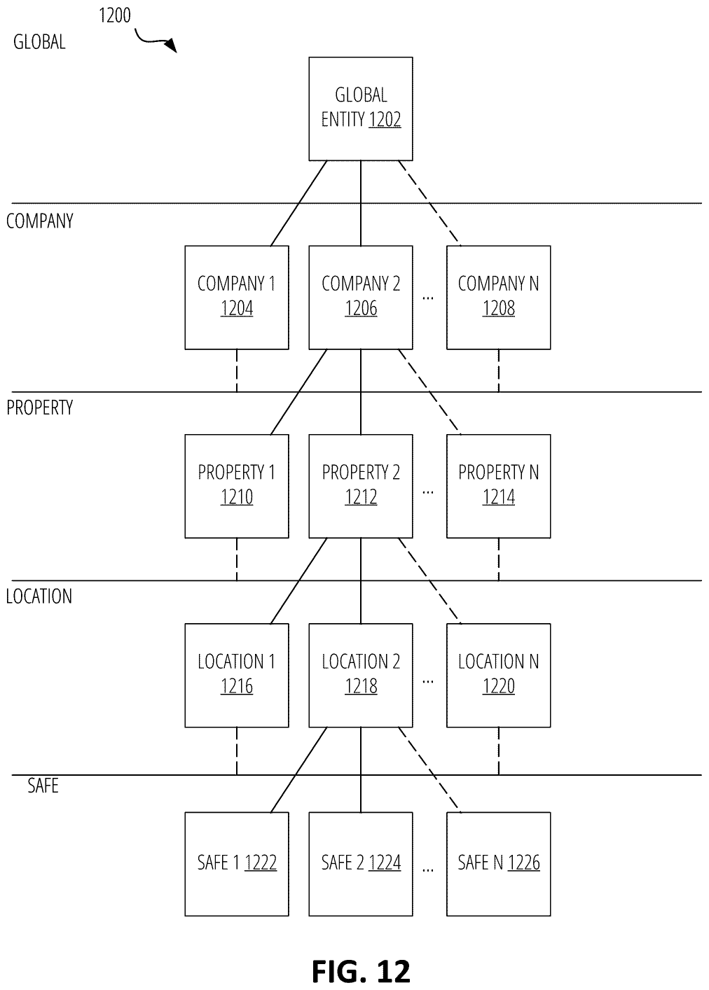

As noted, safes according to this disclosure may connect to and communicate with a backend system (sec, e.g., FIG. 11A to FIG. 12 and related discussions) and other computing devices (e.g., a smart phone). In certain implementations, substantially all data stored in memory unit 1004 may be transmitted to or otherwise accessible to the backend system. In other implementations, only certain data may be shared or communicated from the safe. For example, in certain implementations, personal data (e.g., login credentials, contact information, credit card/banking information, biometric data, etc.) for users of safe 1000 may be stored locally in memory unit 1004 only and may be inaccessible from external devices. Regardless of whether data is maintained locally only or is remotely accessible, safe 1000 may be configured to encrypt or otherwise apply heightened security measures when storing sensitive data.

In certain implementations, data storage behavior of safe 1000 may be based in part on whether safe 1000 is connected to a network and capable of transmitting data to a backend system. For example, when safe 1000 is actively connected to a network, safe 1000 may periodically transmit data stored in memory unit 1004 to a backend system. In response to a loss of network connectivity, safe 1000 may continue to store data in memory unit 1004. When connectivity is restored, safe 1000 may transmit or otherwise make available the collected data to the backend system.

As illustrated in FIG. 10, safe 1000 may be generally divided into subsystems corresponding to the various features and functions of safe 1000. While illustrated as discrete modules or blocks, this representation is intended only for clarity and should not imply any structure or arrangement of the related components of safe 1000. The subsystems of safe 1000 are intended as non-limiting examples of subsystems that may be included in implementations of this disclosure. Accordingly, safes within the scope of this disclosure may include more or fewer subsystems and related functionality than shown in FIG. 10.

Audio subsystem 1006 facilitates audio input and/or output of safe 1000. For example, audio subsystem 1006 may include a speaker, microphone, and corresponding electronics for both producing sound and receiving audio input.

In at least some implementations, audio subsystem 1006 may operate in conjunction with other subsystems, such as communications subsystem 1014 and camera subsystem 1040 (both of which are described below in further detail). For example, audio subsystem 1006 may operate in conjunction with communications subsystem 1014 to facilitate audio or audiovisual communication between safe 1000 and a remote device associated with safe 1000. For example, communications subsystem 1014 and audio subsystem 1006 may operate to initiate an audio or audiovisual call between a local user of safe 1000 and a hotel front desk, property owner, or similar entity. As another example, safe 1000 may be configured to initiate audio or audiovisual communication using audio subsystem 1006 in response to one or more unsuccessful attempts to open/access safe 1000. As with the previous example, such a communication session may be with a hotel front desk, a property owner, or similar entity; however, in response to security related incidents, safe 1000 may also be configured to initiate a communication session with a security team, a dispatch service (e.g., a police or other emergency dispatch service), and the like.

Safe 1000 may also be configured to record audio input and/or output by audio subsystem 1006 automatically or manually. In certain implementations, safe 1000 may record audio data corresponding to communication sessions between safe 1000 and another communication or computing device. Audio subsystem 1006 may also or alternatively be configured to begin audio recording in response to one or more events. For example, audio subsystem 1006 may begin recording audio in response to unauthorized or unsuccessful attempts to access safe 1000 or sensor readings indicative of tampering.

Power subsystem 1008 controls power management, distribution, and storage. Among other elements, power subsystem 1008 may include a power supply and corresponding power electronics (e.g., rectifiers, transformers, etc.) for converting input power as needed for the various systems and subsystems of safe 1000. In one specific example, power subsystem 1008 may include an external power inlet (such as power inlet 170 of safe 100 shown in FIG. 9) or power cord configured to be plugged into a power source. For example, the power inlet may be configured to include or receive a power cable adapted for plugging into a wall outlet (e.g., a 110-240V wall outlet). As another example, the power inlet may be configured to receive a multi-purpose connector capable of providing power, such as but not limited to a USB connection (e.g., USB-C).

In at least certain implementations, power subsystem 1008 may also include one or more battery systems. Among other things, such battery systems may be configured to provide backup power in response to a power outage or disconnection of safe 1000 from a power source. Power subsystem 1008 may also be configured to transmit one or more alerts or alarms (e.g., to an owner of safe 1000 or a hotel front desk) in response to disconnection of safe 1000 or switching of safe 1000 to battery/backup power. Safe 1000 may be configured to generate such transmissions as one-time events (e.g., immediately following disconnection/switching to battery power) or periodically until the power issue is resolved. Safe 1000 may also generate and transmit corresponding messages in response to non-battery power being restored.

This disclosure further contemplates that power subsystem 1008 may include one or more wireless power interfaces, such as an inductive charging interface. For example, safes according to this disclosure may include a wireless charging interface integrated into one or more locations of the body assembly of the safe. In one specific example, a wireless charging interface may be integrated into a top surface of the body assembly such that a user may charge devices by placing them on top of the shelf. Alternatively, or in addition to an external charging interface, safes according to this disclosure may include charging interfaces integrated into the internal volume of the body assembly to facilitate charging of devices contained within safe 1000.

Lighting subsystem 1010 controls operation of the various lighting functions of safe 1000. Safes according to this disclosure may include an internal lighting system and/or an external lighting system. Each of the internal lighting system and external lighting system may include one or more lighting elements (e.g., but not limited to LEDs or LED strips) and related electronics for controlling operation of the lighting elements. For example, safe 100 is illustrated in the figures as including external lighting system 118, which may be an LED strip running underneath and behind front panel 108. Similarly, one or more LED bulbs or strips may also be disposed within body assembly 102 to illuminate safe volume 136.

Lighting subsystem 1010 may be configured to modify various lighting parameters either automatically or in response to a command received from a user through the user interface of safe 1000 or from a remote computing device (e.g., a smart phone). Among other lighting parameters, lighting subsystem 1010 may control one or more of the brightness, color, pattern, and timing of the internal lighting system or external lighting system. For example, in certain implementations, a user may select a color and brightness of the external lighting system based on his or her personal preferences and may configure the external lighting system to illuminate for a 30-second period following any interaction between a user and the safe. As another example, lighting subsystem 1010 may be automatically configured to illuminate the internal lighting system and/or the external lighting system in response to detected events. For example, in response to a user successfully accessing safe 1000, lighting subsystem 1010 may illuminate the external lighting system in a green color. Similarly, failed access attempts may result in lighting subsystem 1010 illuminating the external lighting system in yellow, red, or similar warning colors. Alerts or alarms (e.g., in response to tampering attempts) may likewise result in lighting subsystem 1010 illuminating the external lighting system accordingly. As yet another example, lighting subsystem 1010 may be configured to automatically illuminate the internal lighting system in response to safe 1000 detecting opening of the safe door and may be configured to automatically turn off the internal lighting system after a defined time or on closure of the safe door. In at least certain implementations, the behavior of lighting subsystem 1010 (e.g., when and how lighting subsystem 1010 illuminates the various lighting systems) may be customized or otherwise modified by a user with sufficient permissions.

In at least certain implementations, lighting subsystem 1010 may operate in conjunction with one or more ambient light sensors. For example, safe 1000 may include an ambient light sensor configured to measure light in the environment surrounding safe 1000. Based on such light measurements, lighting subsystem 1010 may automatically dim or brighten the lighting systems of safe 1000 or otherwise modify lighting-related parameters.

Lock actuator subsystem 1012 include the electromechanical components of safe 1000 for physically locking and unlocking safe 1000. For example, safe 100 of the previous figures includes each of locking bolt 130a and locking bolt 130b, which can be selectively extended and retracted to lock and unlock safe 100, respectively. To provide such functionality, lock actuator subsystem 1012 may include a drive system including a solenoid, motor, or similar actuator that can be activated and controlled, e.g., in response to a lock or unlock signal from processor 1002. Lock actuator subsystem 1012 may further include gears or similar transmission elements for converting motion of the actuator to corresponding motion of a locking element, such as locking bolt 130a and locking bolt 130b of safe 100.

Communications subsystem 1014 is configured to facilitate communication between safe 1000 and external computing systems and devices. In at least certain implementations, communications subsystem 1014 may include components for supporting communication via one or more communication protocols/modalities. In certain implementations, safe 1000 may be network-enabled and communications subsystem 1014 may support communication by a corresponding wired (e.g., Ethernet) or wireless network protocol (e.g., Wi-Fi, 4G/5G (or other cellular network protocol), etc.). While not illustrated in the figures, in implementations in which safe 1000 supports wired communication, safe 1000 may include a corresponding port (e.g., an Ethernet port). Alternatively, or in addition to network communication, communications subsystem 1014 may support one or more communication protocols for direct communication between devices, such as Bluetooth or Near Field Communication (NFC). More generally, communications subsystem 1014 includes any necessary hardware and software/firmware for facilitating communication with other devices.

As discussed below in further detail, safes according to this disclosure may be configured to communicate with one or more computing systems and/or applications. For example, later sections of this disclosure detail interaction between safes and a remote safe management system. In other implementations, safes according to this disclosure may be configured to communicate with and interact with other computing systems and networks, such as a hotel management system. Regardless of the computing system or application with which the safe communicates, such communication may be facilitated by a corresponding interface, such as an application programming interface (API). Accordingly, in addition to the various components and software/firmware for communicating using one or more communication protocols noted above, communications subsystem 1014 may further include the necessary libraries, processes, interfaces, etc. for communicating with other systems and applications.

Touchscreen subsystem 1016 includes the hardware and software components for supporting a touchscreen (e.g., touchscreen 116 of safe 100, shown in FIG. 1). More specifically, touchscreen subsystem 1016 generally controls both the visual output of the touchscreen and the receipt and processing of inputs provided by a user by touching the touchscreen (and optionally supporting multi-touch functionality). In at least certain implementations, touchscreen subsystem 1016 may be substituted with a display subsystem including a screen for providing visual output. In such implementations, the user may provide input via other control elements of safe 1000 (e.g., buttons, a keypad, a touchpad, etc.) or through a supplemental device (e.g., a smartphone) connected to safe 1000.

Internal ports subsystem 1018 corresponds to one or more ports that may be included within the internal volume of safe 1000. An example of such ports is shown in FIGS. 8A as first port 162 and second port 164, which are integrated into internal electronics assembly 150. In certain implementations the internal ports provide charging capability to devices stored within safe 1000. In other implementations, the internal ports may also permit communication or other access to devices stored within safe 1000. In such implementations, communication via the internal ports can facilitate communication with devices within safe 1000 that are unable to communicate wirelessly due to the safe body interfering/blocking signals generated by or sent to the devices. As previously discussed, internal ports of safes according to this disclosure are not limited to any specific type and can be modified as needed.

External port subsystem 1024 includes the hardware and software for interfacing and connecting safe 1000 with external systems. In certain implementations, external port subsystem 1024 provides a power interface for safe 1000 and includes suitable power electronics for receiving power from an external source (e.g., a 120V wall outlet) and providing the received power to power subsystem 1008. Similar to internal ports subsystem 1018, external port subsystem 1024 may include ports or similar interfaces for facilitating communication with external devices.

Sensors 1026 represents the various sensors and sensor-related systems that may be included in safes according to this disclosure. Among other things, sensors 1026 include sensors configured to measure one or more of a current state of safe 1000 or a component of safe 1000 or an environmental condition in or around safe 1000. Sensors 1026 may include a wide range of sensor types with the specific sensors shown in FIG. 10 intended to be non-limiting examples.

In general, each of sensors 1026 is in communication with or otherwise configured to provide data to processor 1002. In response to receiving data, processor 1002 may perform various actions including, but not limited to, storing the sensor measurements, issuing an alert/alarm, entering into an alert/alarm/lockdown state, transmitting a message to an external computing session, and initiating a communication session with an external device. Depending on the type of sensor used, processor 1002 may initiate such responses when a signal or data is received from a sensor or when a sensor measurement received by processor 1002 exceeds a benchmark or threshold. For example, processor 1002 may generate an alert/alarm/communication in response to receiving any signal from a door sensor configured to detect when the safe is opened. In contrast, processor 1002 may receive temperature measurements for the internal volume of safe 1000 and may only generate an alert/alarm/communication when the internal temperature falls outside of a predetermine range.

Temperature sensors 1028 include internal and/or external temperature sensors configured to measure temperature within the internal volume of safe 1000 and the surrounding environment, respectively. The internal temperature of the safe may be of interest to a user if the safe is being used to store heat-sensitive items. The internal temperature of the safe may also be used to detect tampering, e.g., using a torch or similar heat generating tool. External temperature sensors may similar be used to measure and detect external environmental conditions that may be damaging to safe 1000 or its contents. For example, safe 1000 may include an external temperature sensor configured to detect fires or similar events in the surrounding environment.

Accelerometer 1030 is configured to measure movement of safe 1000. Among other things, measurements from accelerometer 1030 of safe 1000 can be used to determine if safe 1000 is being moved or tampered with. More generally, accelerometer 1030 may correspond to any sensor configured to measure motion such as, but not limited to, gyroscopes, accelerometers, magnetometers, piezoelectric sensors, and inertial measurement units.

Door sensor 1032 is configured to measure a state or change in state of the door of safe 1000. So, for example, door sensor 1032 may measure if the door is open, if the door is closed, and transitions between the door being opened and closed. In certain implementations, door sensor 1032 may be associated with a timer or similar functionality configured to measure the duration for which the door is in a given state (e.g., how long safe 1000 is left open).

Lock sensor 1034 is configured to measure a state or change in one or more locking mechanisms of safe 1000. Like door sensor 1032, lock sensor 1034 can be configured to determine whether a locking mechanism is engaged, is disengaged, transitions between an engaged and disengaged state, and is transitioned using a key or a motor of safe 1000.

Humidity sensor 1036 includes one or more sensors configured to measure humidity in and/or surrounding safe 1000. Measuring and alerting based on humidity is particularly beneficial when safe 1000 is used to store humidity-sensitive items, such as documents, electronics, and medication/medical supplies.

Other sensors 1038 is intended as a catchall for other sensors that may be included in safe 1000. As noted above, safe 1000 may generally include any suitable sensor for measuring a state of safe 1000 or either of an internal or external environment. Examples of other sensors include, without limitation, light sensors (e.g., an ambient light sensor for automatic control and activation of the external lights, touchscreen, etc.), pressure sensors (e.g., a pressure plate within safe 1000 configured to measure the presence of items within 1000), radiation sensors, and touch sensors (e.g., capacitive sensors, for detecting when safe 1000 is touched by a person).

Notably, certain other subsystems described in this section may also be considered sensors for purposes of this disclosure. For example, as noted above, audio subsystem 1006 may include a microphone or similar device that could be configured as a sound sensor for measuring environmental noises. Similarly, the touchscreen of touchscreen subsystem 1016 may function as a touch sensor.

Camera subsystem 1040 includes hardware and software components for operating each of an internal camera subsystem 1042 and/or external camera subsystem 1044, both of which are included in safe 1000. External camera subsystem 1044 may include the hardware and software components necessary to operate an external camera assembly, such as external camera assembly 120 of safe 100, which is described above in further detail. Similarly, internal camera subsystem 1042 may include the hardware and software components necessary to operate an internal camera assembly such as internal camera assembly 154 of safe 100 (shown, e.g., in FIG. 8A and FIG. 8B).

As with audio subsystem 1006, camera subsystem 1040 may be configured to record video in response to one or more events. For example, camera subsystem 1040 may begin recording video using external camera subsystem 1044 in response to unauthorized or unsuccessful attempts to access safe 1000 or sensor readings indicative of tampering. This disclosure also contemplates that either of audio subsystem 1006 or camera subsystem 1040 may be remotely triggered to begin recording, e.g., by receiving a corresponding command from a user of safe 1000.

Safe 1000 further includes a biometrics subsystem 1020 configured to support one or more methods of biometric authentication. Biometrics subsystem 1020 may include both hardware and software components for capturing and analyzing biometric data. As previously discussed in the context of safe 100, at least certain implementations of this disclosure include a fingerprint reader. In such implementations, biometrics subsystem 1020 may include hardware for capturing an image of a user's fingerprint and the necessary software algorithms for analyzing a captured fingerprint and determining whether the fingerprint corresponds to an authorized user of safe 1000.

While a fingerprint reader is used in this disclosure as a primary example of a biometric authentication, this disclosure contemplates that safes of this disclosure may rely on one or more other biometric authentication methods in addition to or as an alternative to a fingerprint reader. For example, and without limitation, implementations of this disclosure may include hardware and/or software components for supporting authentication using fingerprints, voice, retinal scans, and facial features. In certain implementations, biometrics subsystem 1020 may rely on other subsystems to perform biometric-based authentication. For example, in implementations in which 1020 supports facial recognition, biometrics subsystem 1020 may operate in conjunction with external camera subsystem 1044 to capture and analyze facial images of users.

Other I/O 1022 is intended to reflect input and/or output components and modules not described above but that may nevertheless be incorporated into implementations of safe 1000. For example, in certain implementations safe 1000 may include one or more buttons for performing various functions, a keyboard/keypad for providing alphanumeric input, a magnetic card reader for card-based authentication, a combination dial, a near field communication (NFC) module for use with a card or fob for contactless access, and the like.

FIGS. 1-9 and 10 illustrate example safes according to the present disclosure with FIGS. 1-9 specifically illustrating a safe having a form-factor similar to a hotel safe. While the form-factor shown in FIGS. 1-9 provides various advantages (e.g., being amenable to storage in a closet or readily relocatable by a user), safes within the scope of this disclosure may have any suitable form factor and include any or all of the features, structure, and functionality discussed herein.

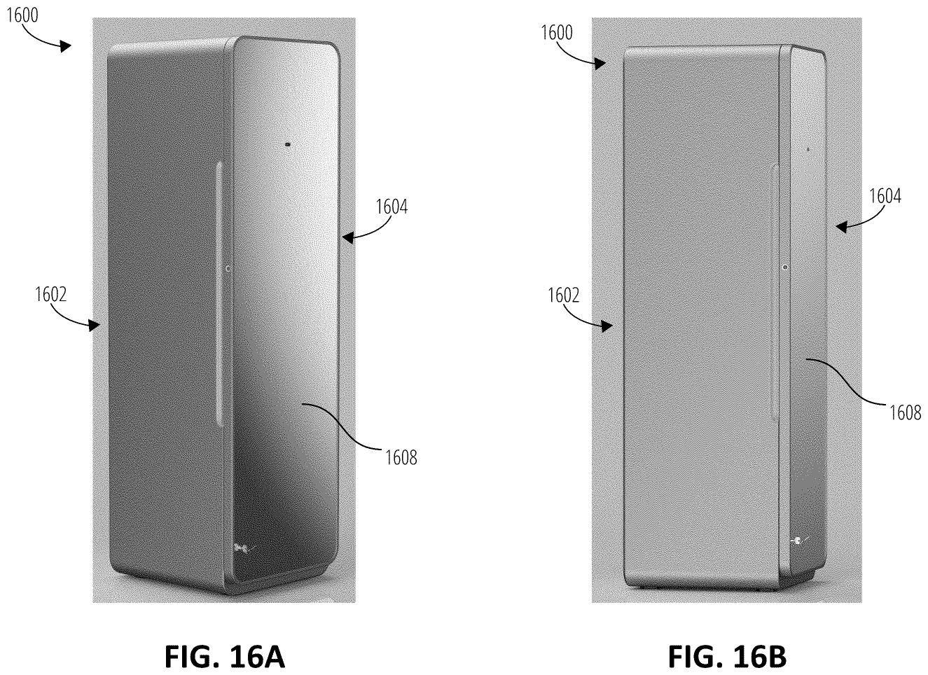

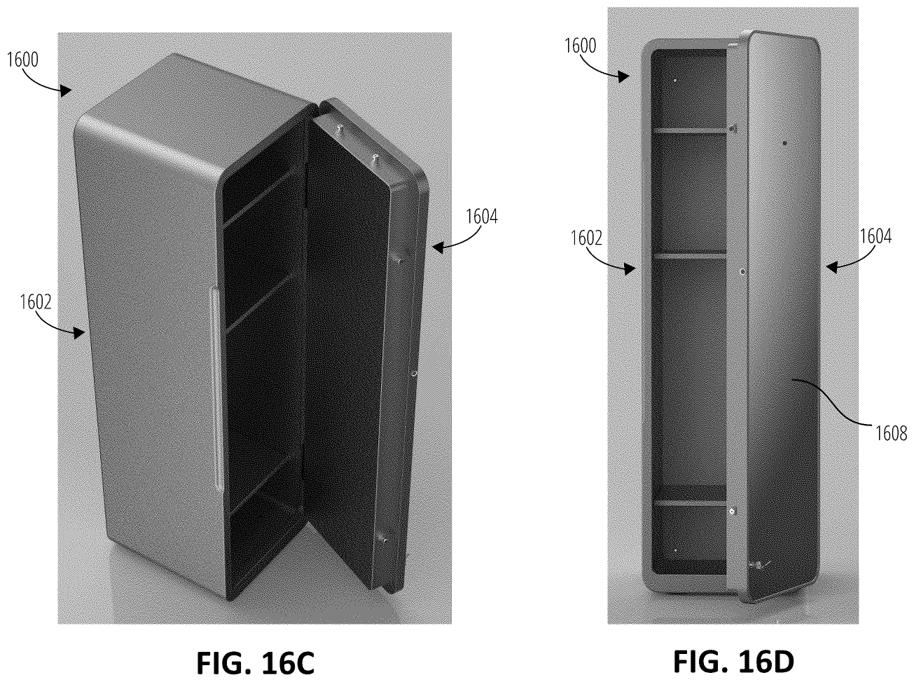

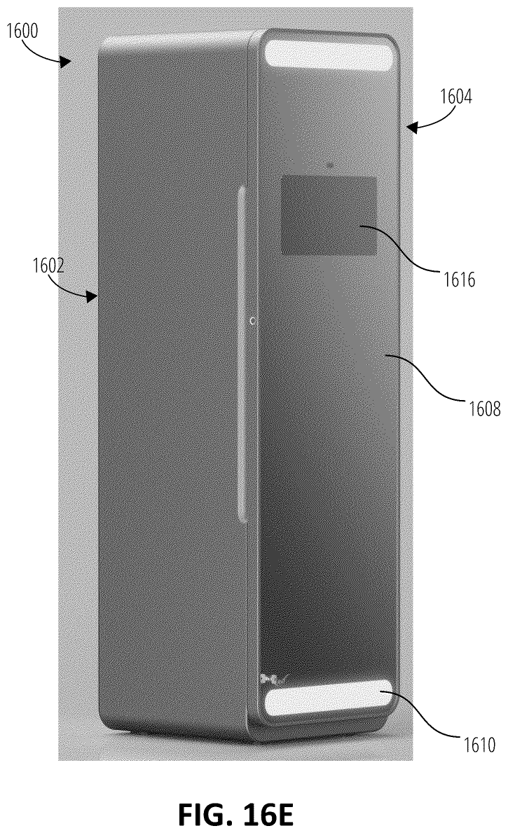

As a first non-limiting example, FIGS. 16A-16E illustrate a safe 1600 having a locker-style form factor. More specifically, FIGS. 16A and 16B illustrate safe 1600 in a closed state from different perspectives, FIGS. 16C and 16D illustrate safe 1600 in a partially open state from different perspectives, and FIG. 16E illustrates safe 1600 in an alternative closed state with external lights illuminated.

As with safe 100, safe 1600 is divided into a body assembly 1602 and a door assembly 1604. Door assembly 1604 is coupled to body assembly 1602 and movable relative to body assembly 1602 to provide access to a safe volume 1636 (indicated, e.g., in FIG. 16C). Door assembly 1604 is lockable and, when locked, prevents access to safe volume 1636. Door assembly 1604 generally includes a front panel 1608, which may include additional components such as a fingerprint reader, a key lock assembly, an external camera assembly, a microphone, a speaker, and any other components and elements discussed herein. As with other implementations of this disclosure, door assembly 1604 may also include a touchscreen 1616, which is indicated in FIG. 16E. FIG. 16E further illustrates an external lighting system 1610 in an illuminated state.

As with safe 100 and other safes of this disclosure, safe 1600 may include mechanical and/or electromechanical locking mechanisms (including those based on biometrics), a range of audio and/or visual systems, sensors (e.g., for detecting tampering), communication capabilities, and the like. Safe 1600 may also be configured to be compatible with various mounting assemblies for coupling safe 1600 to other structures.

As shown in the figures, safe 1600 may include a series of shelves or similar internal structural components for supporting and organizing contents of safe 1600. While shown as including three shelves, this disclosure contemplates that safe 1600 may include any suitable number of shelves, compartments, drawers, removable containers, hooks, clips, or any other similar elements. For example, in certain implementations, safe 1600 may be a gun safe and may include a rack or similar support structure for supporting and retaining long guns in addition to shelves, containers, and the like for storing and organizing other guns and gun-related items such as handguns (or similar small arms), cleaning and maintenance supplies, and the like. This disclosure further contemplates that safe 1600 may include additional lockable compartments. Such lockable compartments may be accessible through a mechanical system (e.g., a key or combination lock) and/or an electromechanical system, including any of the systems or interfaces discussed herein for primary access to safe 1600.

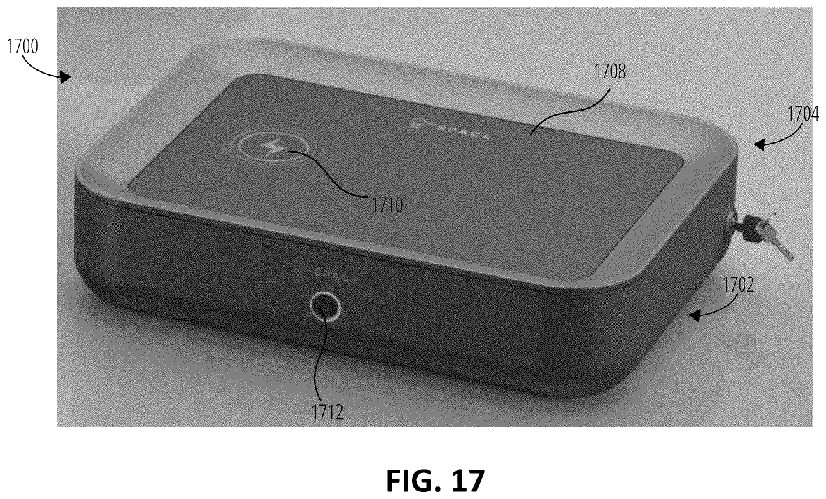

In contrast to safe 1600, FIG. 17 illustrates a safe 1700 having a smaller form factor than safe 100 of FIGS. 1-9. As with previous safes, safe 1700 is divided into a body assembly 1702 and a door assembly 1704. Door assembly 1704 is coupled to body assembly 1702 and movable relative to body assembly 1702 to provide access to a safe volume (not indicated). In contrast to previous implementations, safe 1700 is configured such that door assembly 1704 forms a lid and opens upward. As with other safes of this disclosure, door assembly 1704 is lockable and includes a top panel 1708. Top panel 1708 may optionally include a touchscreen to facilitate interaction with safe 1700 and is also shown in FIG. 17 to include a wireless (e.g., inductive) charger 1710.

In contrast to previous implementations in which safes integrated fingerprint readers into door assemblies, safe 1700 includes a fingerprint reader 1712 integrated into body assembly 1702. More generally, this disclosure contemplates that various components may be included in either a body or door assembly of a given safe. So, for example, certain sensors, audio-visual components, and the like may be included in either of a body assembly and a door assembly of a given safe, including being distributed between the two assemblies.

In light of its smaller form factor, safe 1700 may be useful in applications in which safe 1700 is to be portable, stored in a compartment, or otherwise required to be smaller or more discreet. For example, safe 1700 may be suitable for storing in a drawer of a nightstand or bedside table, e.g., for use in storing a handgun. As with safe 1600, safe 1700 may include any or all of the various features of safes according to this disclosure. For example, and without limitation, safe 1700 may permit both mechanical and biometric-based access, may include various audiovisual components, sensors for measuring movement or tamper-related activity, and components for facilitating communication with other computing devices or systems.

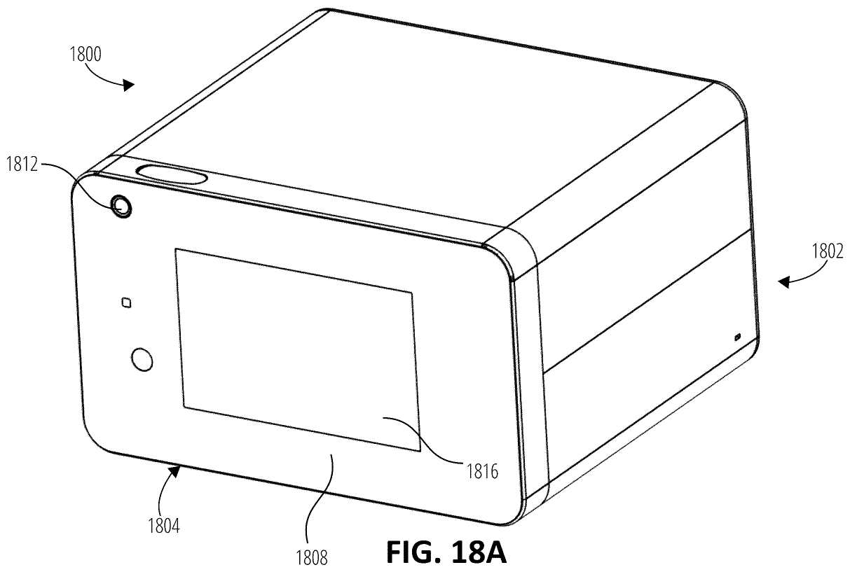

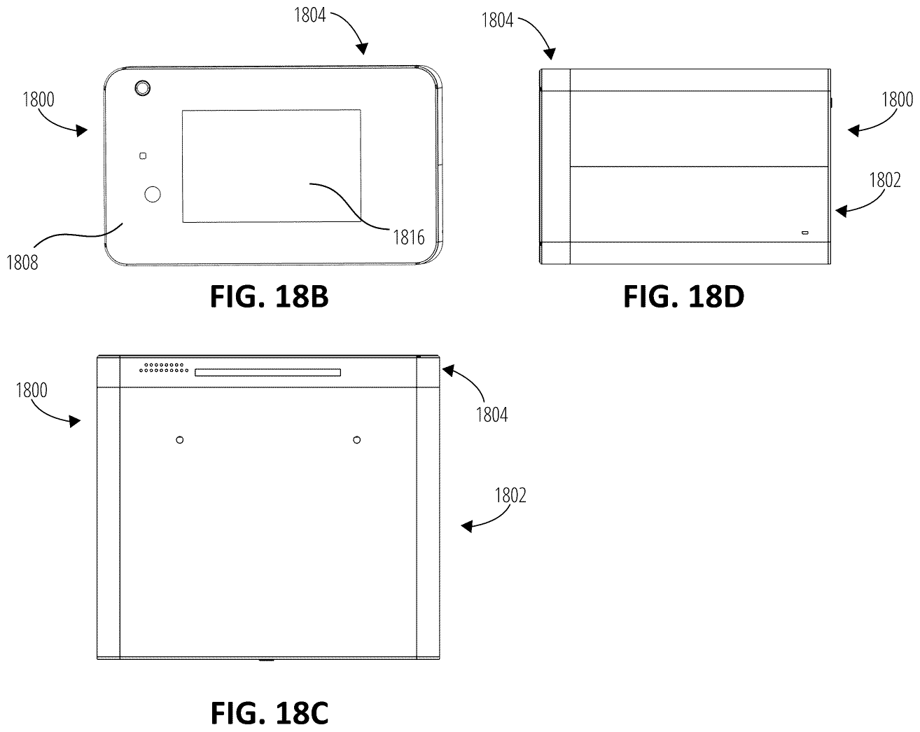

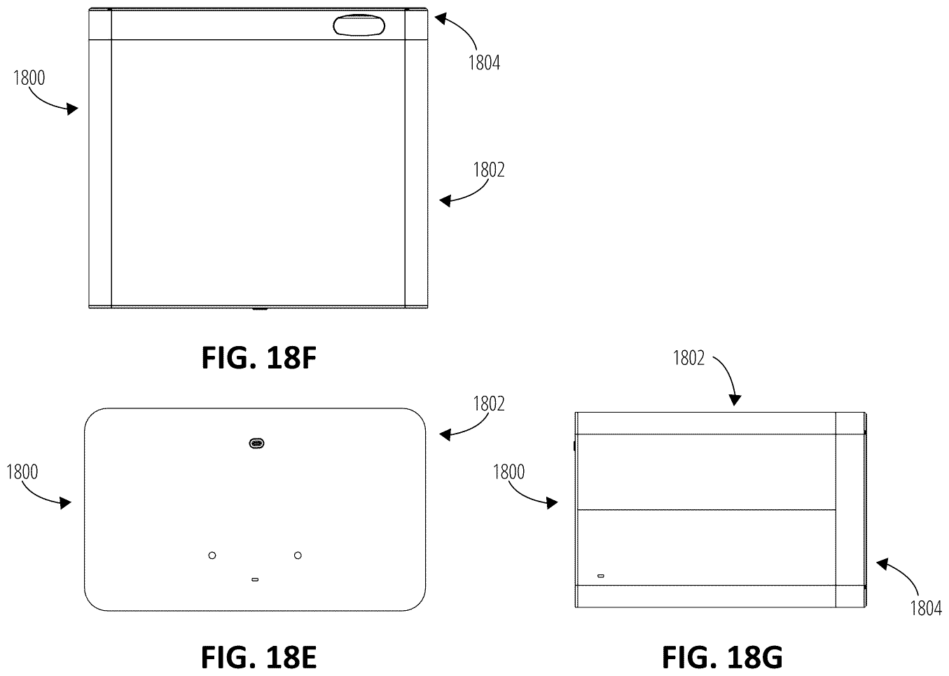

Finally, FIGS. 18A-18G illustrate a safe 1800 in accordance with another implementation of the present disclosure. The figures illustrate safe 1800 as having a form factor similar to that of safe 100 shown in FIGS. 1-9; however, safe 1800 excludes certain features of safe 100 and varies in certain design elements.

For example, like safe 100, safe 1800 is divided into a body assembly 1802 and a door assembly 1804. Door assembly 1804 is coupled to body assembly 1802 and movable relative to body assembly 1802 to provide access to an internal safe volume. Door assembly 1804 is lockable and generally includes a front panel 1808.

Safe 1800 is intended to provide an example of a simplified version of safe 100. Accordingly, while front panel 1808 includes a touchscreen 1816 and fingerprint reader 1812, it excludes other components included in safe 100, such as an external camera assembly and other forward-facing sensors (e.g., motion sensor 114). In further contrast to the front panel 108 of safe 100, which has a sloped face, front panel 1808 of safe 1800 has a simpler, flat-front design. Safe 1800 is otherwise intended to be substantially similar to safe 100. Accordingly, to the extent specific structural/mechanical, electrical, and electromechanical components of safe 1800 are omitted from this discussion, reference should be made to the various components and features of safe 100, discussed above in the context of FIGS. 1-9.

More generally, this disclosure contemplates that safes according to this disclosure may have a wide range of form factors and may include any combination of features and functionality discussed herein. So, while this disclosure illustrates and discusses certain specific safe designs, such designs should be considered non-limiting. Stated differently, this disclosure contemplates safes within the scope of this disclosure may have any suitable shape, size, and geometry and may include that include any combination of features and functionality described herein.

This disclosure further contemplates that certain elements of safe 1000 shown in FIG. 10 and discussed above may be integrated into external devices in communication with safe 1000. For example, while most implementations of safes according to the present disclosure include an integrated touchscreen, this disclosure also contemplates that a touchscreen or similar device may be a separate device (e.g., a tablet, laptop computer, smartphone, etc.) in communication with safe 1000 and that safe 1000 may omit an integrated touchscreen. In such implementations, any or all functions provided by integrated touchscreens described in this disclosure may instead be provided by the separate device. As another example, safe 1000 may be configured to communicate with and be unlockable using a remote/separate keypad, biometric reader, card reader, or the like. In at least certain implementations, safe 1000 may be accessible using only a remote device with all or at least some local access options (e.g., an integrated touchpad/touchscreen, biometric reader, etc.) excluded from the safe.

Given the sophistication and broad range of features of safes according to this disclosure, certain implementations may include an interactive setup tool or “wizard” to help users install and configure a given safe or group of safes. Such setup tools may provide step-by-step guidance to users for installation and configuration of safes, explain various safe functions and features to users, and the like. In at least certain implementations, the interactive setup tool may include interactive modules, multimedia (e.g., videos), and similar elements to facilitate setup. In still other implementations, some or all portions of the interactive tool may also include controls (e.g., buttons, links, etc.) for opening a communication session (e.g., a phone or video call or chat session) with a technical support desk or bot for answering a user's questions and/or providing more specific guidance to the user.

While safes according to this disclosure may be configured to operate as standalone units, they may also operate as Internet of Thing (IoT) or similar smart or connected devices operating within a broader computing environment. For example, FIG. 11A illustrates a first view of a computing environment 1100 including multiple safes according to this disclosure in addition to various systems for managing, operating, and facilitating communication with and between such safes. FIG. 11B illustrates a supplemental view of computing environment 1100 that excludes certain elements of computing environment 1100 as shown in FIG. 11A but including various additional computing devices.

For purposes of the following discussion and referring to FIG. 11A, computing environment 1100 includes four distinct geographic locations indicated as property 1 1114, property 2 1118, property 3 1122, and property 4 1126. Such properties are provided merely as examples to illustrate aspects and implementations of this disclosure and are not intended to be limiting. More generally, and as described in the context of FIG. 12, below, a “property” serves as a logical group within which one or more safes may be associated and that may be further sub-divided (e.g., into “locations” as described below).

Property 1 1114, for example, is intended to represent a personal residence, rental property, rental unit, etc. including a single safe, i.e., safe 1116. Property 2 1118, in contrast, is intended to represent a residential building including multiple safes. So, for example, property 2 1118 may correspond to a single-family residence, a multi-family building, an apartment complex, a dormitory, or any other similar building that may include multiple safes, i.e., safes 1120. In a multi-unit building, for example, each unit within the building may include a respective safe of safes 1120. Property 3 1122 is intended to represent a business or office building that may include multiple safes, e.g., safes 1124. Similarly, property 4 1126 is intended to represent a multi-unit hospitality-type business, such as a hotel, in which multiple units within the business each include one or more respective safes (collectively indicated as safes 1128).

As shown in FIG. 11A, each safe within computing environment 1100 is configured to communicate with a safe management system 1102. Among other things, safe management system 1102 is configured to collect and process data from safes, to facilitate configuration of safes, to remotely monitor safes, to remotely operate safes, and to manage users of safes. In computing environment 1100, safe management system 1102 is illustrated as a remote (e.g., cloud-based) backend system configured to communicate with each safe over a network 1104 (e.g., the Internet). In at least certain implementations, communication between safe management system 1102 and a respective safe may be facilitated by a corresponding interface, such as an application programming interface (API), e.g., API 1112.

Safe management system 1102 is shown in FIG. 11A as being remotely located from specific properties and is intended to reflect a global system. However, this disclosure contemplates that safe management system 1102 may be implemented on a smaller scale. In one implementation, safe management system 1102 may be an internal system of an organization intended to monitor and operate safes within the organization exclusively. For example, a hotel chain may operate and maintain an instance of safe management system 1102 to support safes within hotels of the hotel chain only. Other implementations of safe management system 1102 may be on a smaller scale, such as on a property-specific or limited geographical region. For example, a hotel, dorm, or apartment complex may have a local server that executes safe management system 1102 for safes within the hotel, dorm, or apartment complex, respectively. On an even smaller scale, safe management system 1102 may be configured to execute on a personal server of a single-family home for purposes of supporting safes within the home.

During operation, safe management system 1102 monitors and manages safes communicatively coupled to safe management system 1102. For a given safe, this generally involves remotely monitoring the state of the safe and receiving event, diagnostic, and other data from the safe. For example, and without limitation, safe management system 1102 may pull or be provided with battery life data, sensor data (e.g., temperature, motion, accelerometer/force, etc. data), connectivity data, software/firmware information (e.g., version), log files, error notices and files, reboot information, up-/downtime statistics, CPU usage statistics, memory usage statistics, GPS data (e.g., from an onboard GPS unit), general usage information (e.g., access statistics), and any other data collected by, maintained, or otherwise made available for a given safe, Safe management system 1102 may also permit or facilitate remote operation of the safe including but not limited to, locking and unlocking the safe, activating and remotely communicating through one or more communication systems of the safe, reconfiguring the safe, modifying or updating user profile data maintained on the safe, providing updates to safe software/firmware, and the like. As discussed below in the context of FIG. 11B, safe management system 1102 may also provide a portal or similar interface for users to access safe-related data, manage safes associated with a user or organization, and access and review reports, statistics, and similar analytics based on data collected by safe management system 1102.

In the implementation illustrated in FIG. 11A, safe management system 1102 is shown as a remote (e.g., cloud-based) platform that facilitates operation of a safe-related ecosystem.

To facilitate the various functions of safe management system 1102, safe management system 1102 may be in communication with or otherwise have access to various data sources, including, but not limited to, a user data source 1106, a safe data source 1108, and a historical data source 1110. FIG. 11A illustrates user data source 1106, safe data source 1108, and historical data source 1110 as being separate from safe management system 1102 but accessible via network 1104; however, in other implementations, any of user data source 1106, safe data source 1108 and historical data source 1110 may be integrated with safe management system 1102. Moreover, while illustrated as discrete data sources in computing environment 1100, such representation is intended for clarity and convenience only. Stated differently, user data source 1106, safe data source 1108, and historical data source 1110 may actually correspond to one or more data sources and may be distributed in any suitable manner.

User data source 1106 may store user profiles with user information including, but not limited to, a username, personal information, contact information, permissions, an avatar or image of the user, one or more user groups to which the user is assigned, and other similar information.

In certain implementations, user data source 1106 may also store authentication data for users. Such authentication data may include fingerprint data, voice recognition data, passwords, pins, alphanumeric codes, and any other similar data that may be used to authenticate the user to access a safe. Among other advantages, remotely storing authentication data may allow a user to access multiple safes using the same authentication credentials. Given the sensitive nature of such data, safe management system 1102 and/or user data source 1106 may be configured to store any authentication data using a suitable encryption method. As an alternative to storing authentication data in user data source 1106, authentication data may be maintained exclusively within the memory of the corresponding safe.

For purposes of this disclosure, the term “user” is intended to generally refer to any individual or entity that interacts with a safe according to this disclosure or safe management system 1102 more generally. The particular permissions assigned to a given user may vary substantially and can change over time. For example, a first user (e.g., a property owner) may assign permissions that are limited in both scope and time to a second user (e.g., a renter or guest). For simplicity and clarity, this disclosure uses the terms “owner”, “premises administrator”, “portal administrator”, and “guest” to differentiate common users and their associated permission sets. This disclosure may also mention a “standard” user, which is generally intended to refer to a user of a safe for primarily personal purposes. In most cases, a standard user will have similar permissions as an owner and a portal administrator. In at least some implementations, permissions available to any user may be limited based on a subscription level or similar arrangement. This disclosure also contemplates that a given user's permissions may vary over time and/or may vary with respect to particular safes or groups of safes.

A “guest”, as used in this disclosure, refers to a low-tier user with permission to access a safe using a suitable authentication method (e.g., safe code/combination, voice recognition, facial recognition, fingerprint, mobile authentication, etc.). A guest is generally unable to add other users to a safe, modify configuration of a safe, access historic data for a safe, or perform other administrative functions. Beyond being associated with a basic level of permissions, the term “guest” should be considered non-limiting. So, for example, while a hotel guest may be considered a “guest” for purposes of accessing a safe in a hotel room, the term “guest” as used in this disclosure is also intended to cover renters, family members, students in a dorm room, employees, or similar users that may only have permission to access a safe.

In some use cases, a guest's permission may be limited based on the occurrence of a particular event. For example, in certain implementations, a guest's permissions may be time-limited with the event being the time period elapsing. As another example, a guest's permission may be limited to a certain number of accesses to a safe. In either case, limitations on a guest's access may be set by another user with appropriate permissions. As yet another example, a guest's permissions may be automatically revoked or suspended in response to the guest checking out of an accommodation. This disclosure also contemplates that guest permissions may be based on data maintained by other computing systems and applications and communications with those systems and applications. For example, safe management system 1102 may be in communication with a reservation system of a hotel or a booking system associated with a vacation rental website. In such cases, the guest's permissions may be tied to communications and data received from the external systems such as the duration of the guest's stay and whether the guest has completed a checkout process.

In direct contrast to a guest, the term “owner” is used herein to refer to a user that has full access and permissions for one or more safes or groups of safes. An owner generally has permission to add and remove users to safes, to reconfigure a safe, to change safe modes, to access and review historical data for one or more safes, to modify permissions of other users, or otherwise perform any function associated with a safe or safe management system 1102.

“Premises administrators” are mid-tier users that may have more permissions than a guest to facilitate use and operation of safes by guests. For example, a premises administrator may have permissions to add and remove guests from a given safe and may have limited permissions to unlock safes either locally (e.g., using the interface of the safe itself) or remotely (e.g., from a hotel room reception desk). By way of non-limiting example, a premises administrator may correspond to a property owner, property manager, hotel manager, or similar user.

Finally, the term “portal administrator” refers to a user with access to a portal or similar interface provided by safe management system 1102. Through the portal, the portal administrator can access historical data, statistics, and analytics for safes associated with the portal administrator or an employer of the portal administrator. So, for example, a portal administrator may be associated with a hotel chain and access the portal provided by safe management system 1102 to review usage statistics and related analytics for safes within hotels of the hotel chain. In certain cases, a portal administrator may also have permissions to remotely unlock or otherwise access functions of a given safe, and, as such, may function as a dispatcher or similar centralized help/customer support desk.

This disclosure also contemplates that portal administrators and other portal users may have varying permissions in the context of the portal. For example, certain portal-based users may have substantially unrestricted access to safe data and functionality while others may be limited to accessing data for analysis and business intelligence purposes but may not have direct access to safe functionality. Similarly, certain portal users may have administrative permissions to add, delete, or modify other portal users and to set the permission levels of those users.

While the foregoing are examples of user types that may be common in applications of safes and systems of this disclosure and that are used in subsequent discussions, the examples are not intended to be limiting or exhaustive. Rather, this disclosure contemplates that permissions associated with a user can be customized and tailored according to a user's specific needs. User permissions may also vary over time and, in certain cases, may be configured to last for only a set period of time or until a certain event occurs. For example, in one implementation, a user may be provided guest permissions to access a safe for a set period of time corresponding to a stay at an accommodation (e.g., a hotel or rental property). A user may alternatively or also be provided guest permissions until safe management system 1102 receives a relevant notification from a user or computing system associated with the accommodation. For example, the guest may perform a check out process using a computing device (e.g., on a personal computing device such as a smartphone, through a kiosk or similar on-premises computing device, or via the safe itself) configured to transmit a checkout notification to safe management system 1102. In response, safe management system 1102 may automatically reconfigure the safe to remove the guest as a user for the safe. A similar process may be implemented using a computing system associated with managing the accommodation, such as a hotel management platform communicatively coupled to safe management system 1102. In such instances, an employee of the accommodation may indicate (e.g., using a computing device with access to the hotel management platform through a portal or application) that the guest has left the accommodation or otherwise checked out. The hotel management platform may then transmit a corresponding communication to safe management system 1102 to trigger reconfiguration of the safe and/or the guests' permissions with respect to the safe.

This disclosure also contemplates that users may be assigned to one or more user groups with corresponding permissions. For example, a hotel chain or similar large-scale organization may include a wide range of employees, each of which may have different permissions based on their role within the organization. By way of non-limiting example, one group of employees may be assigned to a user group corresponding to on-premises managers and, by default, may be assigned to a “manager” user group with permissions similar to those of a premises administrator, noted above. Another group of employees within the same organization may correspond to an analytics or operations team and may be assigned to an “analyst” user group. Such users may not have permissions to unlock or perform similar operations associated with a given safe but may be able to access previously collected data and/or corresponding analyses or reports.

More generally, this disclosure contemplates that user groups may be delineated in any meaningful way with each user group being associated with a corresponding set of permissions. For example, user groups may be defined based on roles within an organization, geographic location, tenure with an organization, user age (or other user characteristics), and the like.

In addition to collecting and managing user data, safe management system 1102 may also be configured to save safe data in safe data source 1108. For example, safe data source 1108 may include an inventory of safes managed by safe management system 1102 and associated characteristics of the safes. For example, and without limitation, safe data source 1108 may include records for each safe including a serial number (or other identifier of the safe), a model, a software/firmware version, an owner, a location, commissioning information (e.g., when the safe was first put into use), and the like.

Like users, safes may similarly be assigned to safe groups based on any suitable attribute or safe characteristics. For example, safes may be grouped into safe groups based on one or more of location, content sensitivity/value, intended use, and the like. Notably, user permissions may be granted/assigned based on safe attributes in addition to or instead of user attributes. So, for example, a user may be a mid-level manager of a hotel and may be assigned to a management user group that includes general permissions associated with a premises administrator, including permissions to access safe contents. However, the specific user may be further limited to safes within a specific hotel and/or to safes only in rooms of the hotel (e.g., not to any safes for storing hotel cash/valuables or sensitive documents). As yet another example, a user may be considered an administrator or manager of a first property with substantial access to safe data and functionality but only an analyst/portal user for a second property.

Historical data source 1110 is intended to store historical data of safes within computing environment 1100 and managed by safe management system 1102. Such data may be requested by or otherwise provided from a given safe to safe management system 1102 for storage in historical data source 1110.

In general, historical data source 1110 contains records of safe activity. Such activity may be in the form of event logs that document any event tracked and measured by a given safe. Example events that may be logged and stored within historical data source 1110 include, without limitation, access-related events (e.g., a date/time when a safe is accessed), authentication-related events (e.g., successful or failed authentication attempts), notifications/alerts/alarms generated by the safe, changes to safe configurations, changes to user data stored at the safe, uses of panic pins (or similar emergency inputs), requests to recover access to the safe, changes to users (e.g., addition of new users, deletion of users, frequency of user changes, etc.) for the safe, and the like. Historical data source 1110 may also store any sensor data collected by one or more of the sensors of a given safe. So, for example, historical data source 1110 may include a history of temperature, motion, and/or light sensor measurements collected by a safe. Historical data source 1110 may also store recordings made using the various video, photographic, and audio subsystems of a safe.

Referring now to FIG. 11B, an alternative view of computing environment 1100. More specifically, FIG. 11B is shown with all but property 1 1114 included for simplicity but further introduces various user computing devices (e.g., user computing device 1132 and user computing device 1140) and an enterprise system 1134 to illustrate access and interaction between users, safes, and safe management system 1102.

User computing device 1140 is intended to represent a personal computing device, such as a smartphone, laptop, or tablet device. As shown in FIG. 11B, user computing device 1140 is configured to be communicatively coupled to safe 1116. For example, user computing device 1140 may store and execute an application configured to connect to and interact with safe 1116. In certain implementations, such coupling may be direct or over a local network associated with property 1 1114 and may be using a wired or wireless connection. For example, in certain implementations, user computing device 1140 may be configured to pair and communicate with safe 1116 using Bluetooth or any other similar short-range communication protocol. Alternatively, user computing device 1140 may connect to and communicate with safe 1116 using a local wired or wireless network including property 1 1114.

In addition to or as an alternative to direct communication between user computing device 1140 and safe 1116, communication between user computing device 1140 and safe 1116 may instead be facilitated by safe management system 1102. So, for example, data or commands may be sent by user computing device 1140 through API 1112 to safe management system 1102 which may then relay the data/commands or otherwise communicate with safe 1116.

In certain cases, communication between may be based on both a local and remote connection. For example, safe management system 1102 may facilitate a multi-factor or dynamic code-based authentication process in which user computing device 1140 communicates with and receives a code from safe management system 1102 which can then be provided to safe 1116 using user computing device 1140.

FIG. 11B also includes user computing device 1132, which is intended to represent a remote computing device associated with property 1 1114 and safe 1116. As with user computing device 1140, user computing device 1132 may be used to perform any suitable function related to safe 1116 provided a user of user computing device 1132 has adequate permissions. As shown, user computing device 1132 communicates with property 1 1114 or safe 1116 through API 1130 or a similar interface. As in the previous example, communication between user computing device 1132 may occur directly or may be facilitated by safe management system 1102.

User computing device 1132 is also intended to represent a user computing device that may be used to monitor multiple properties and/or safes remotely. So, for example, while user computing device 1140 may be configured to access and interact with only certain safes at a certain property (e.g., safe 1116 or property 1 1114), user computing device 1132 may be configured to access and monitor one or more safes across one or more properties, e.g., through a portal provided by safe management system 1102.

As further illustrated in FIG. 11B, safe management system 1102 may be configured to interact with an enterprise system 1134. For example, enterprise system 1134 may correspond to a computing system associated with a hotel chain or similar organization. Enterprise system 1134 may include one or more servers (such as enterprise server 1142) and an associated enterprise network 1136 for computing devices within the enterprise system 1134 (e.g., user computing device 1138).

In implementations in which safe management system 1102 communicates with enterprise server 1142, safe management system 1102 may be configured to host and provide access to a portal for users associated with enterprise system 1134 to access data and otherwise interact with safes associated with enterprise system 1134. In other implementations, enterprise server 1142 may communicate with and receive data from safe management system 1102 for use by applications, analytics and reporting systems, etc., hosted within enterprise system 1134. As illustrated, enterprise system 1134 or computing devices within enterprise system 1134 may be configured to interact with and communicate with safe management system 1102 or any safes within computing environment 1100 via a corresponding interface, such as API 1130.

This disclosure contemplates that a given safe may be configured to perform any functions of user computing device 1132, user computing device 1138, and user computing device 1140 described herein by way of computing components included in the safe. Stated differently, a safe (or more specifically, the computing components included in the safe) may function as a user computing device for performing any of the functions described herein. So, for example and among other things, computing components of a given safe may be used to not only access, configure, and monitor the safe associated with the computing components but to access, configure, and monitor other safes; access a portal supported by safe management system 1102, and the like.

While not specifically shown in FIGS. 11A and 11B, this disclosure contemplates that safes according to the present disclosure may be integrated into broader security-, computing-, and/or IoT-related systems that can include a wide range of other devices and computing systems. In such applications, safe management system 1102 may provide functionality related to monitoring, managing, analyzing, and operating such additional systems or may operate in conjunction with one or more other device/system management platforms. For example, computing environment 1100 may further include camera systems, audio-visual systems, sensor systems, and the like from which safe management system 1102 may receive data and recordings and to which safe management system 1102 may transmit instructions. As another example, safe management system 1102 may provide data to, retrieve data from, or otherwise interact with another backend system configured to manage other devices within computing environment 1100. For example, safe management system 1102 may be configured to collect and provide safe recordings to a backend system for operating and managing a closed-circuit camera system in order to supplement recordings of the closed-circuit camera system with those made by safes managed by safe management system 1102.

As previously noted, safes according to this disclosure may be logically grouped and organized within safe management system 1102. FIG. 12 is a hierarchy 1200 illustrating an example grouping of safes corresponding to a large organization, such as a family of commonly owned hotel chains.

As illustrated, hierarchy 1200 is generally organized under a global entity 1202 under which one or more companies (e.g., company 1 1204, company 2 1206, company N 1208) may be grouped. For example, global entity 1202 may correspond to an entity that owns multiple hotel chains, with each company within hierarchy 1200 corresponding to a particular hotel chain.

As shown, each company may, in turn, be associated with or contain multiple properties. In hierarchy 1200, company 2 1206 is shown as including each of property 1 1210, property 2 1212, and property N 1214. Referring again to the hotel-related example, each property may correspond to a specific location for a hotel of a given brand.

Drilling down further, each property may include multiple locations. For example, property 2 1212 is shown in hierarchy 1200 as including location 1 1216, location 2 1218, and location N 1220, each of which may correspond to a room within the hotel corresponding to property 2 1212. Finally, each location (e.g., hotel room) may include multiple safes (e.g., location 2 1218 includes each of safe 1 1222, safe 2 1224, and safe N 1226).

Hierarchy 1200 is intended only as an example of a logical grouping of safes and this disclosure recognizes that other logical groupings may include more or fewer levels in the hierarchy, different parameters defining each level of the hierarchy, and other similar modifications. For example, hierarchy 1200 may further include a “region” level between the “company” and “property” levels that groups properties based on geographic region. Conversely, when global entity 1202 is a renter with only a few properties and each property having only one safe, each of the “company” and “location” levels of hierarchy 1200 may be omitted.

In general, the hierarchical and logical grouping illustrated in the example of FIG. 12 can be an effective approach to organizing and grouping data collected from safes within a multi-safe application. For example, using a portal provided by safe management system 1102, a user may quickly and readily access data for safes within a specific property of a hotel chain or view and compare summary data on a chain-by-chain or regional basis. Hierarchical organization can also be an effective and efficient way of assigning user permissions. For example, a hotel manager may be assigned permission to access any safes and view summary data for any safes within a property assigned to the hotel manager. In contrast, a more senior employee may have similar access for all safes within a geographic region or hotel chain.

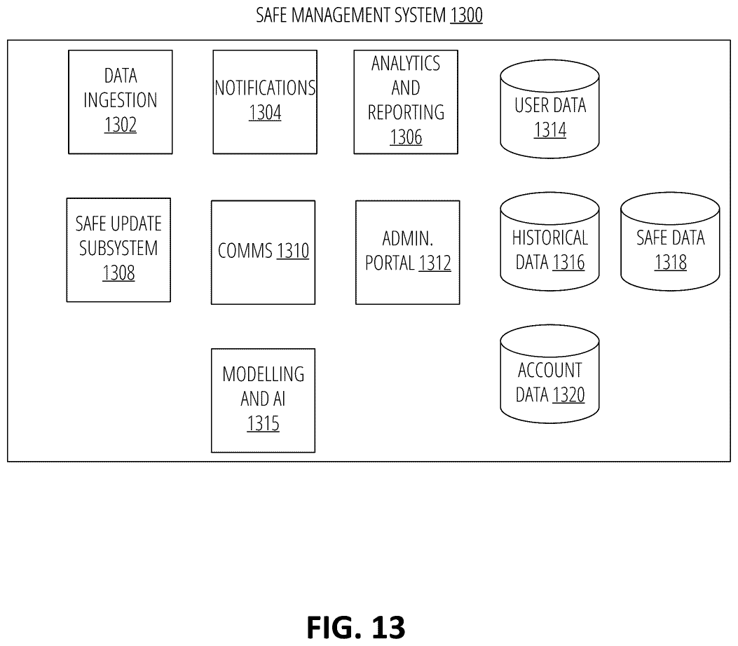

FIG. 13 is a block diagram of a safe management system 1300 according to this disclosure. As shown, safe management system 1300 may include various data sources and modules/subsystems for performing various functions and providing various features related to management and operation of safes. While the various subsystems and data sources of safe management system 1300 are shown in FIG. 13 as being distinct elements, such an arrangement is intended only as an example and is primarily for clarity and convenience for the following discussion. More generally, the various subsystems of safe management system 1300 may include any suitable hardware and/or software components and subsystems may be combined in any suitable way.

As shown, data ingestion subsystem 1302 includes or may have access to various data sources including, but not limited to a user data source 1314, a historical data source 1316, a safe data source 1318, and an account data source 1320. In contrast to FIG. 11 in which the various data sources are remote from safe management system 1102, user data source 1314, historical data source 1316, and safe data source 1318 are illustrated as being integrated into safe management system 1300. Otherwise, the general purpose and function of the data sources correspond to those of FIG. 11 and are described above in further detail.

FIG. 13 introduces account data source 1320, which, like the other data sources, may be integrated into safe management system 1300 or may be remote but accessible by safe management system 1300. In certain implementations, functions of safes and/or access to safe management system 1300 and its various features may be based on a subscription or other payment model. To facilitate such payments, account data source 1320 may store account-and payment-related information for users of safe management system 1300. For example, account data source 1320 may store payment form and type information (e.g., credit card information), billing details, payment and billing histories, account balances, and other information and records associated payments.

Turning now to the various subsystems of safe management system 1300, data ingestion subsystem 1302 is intended to encompass the various features of safe management system 1300 for receiving, processing, and storing data. As previously discussed in this disclosure, safes in communication with safe management system 1300 may include various sensors, communication modules, and the like that transmit data to safe management system 1300. Similarly, safe management system 1300 may regularly communicate with a range of non-safe computing devices and receive corresponding data from such devices. Accordingly, data ingestion subsystem 1302 is configured to receive data from any device or computing system associated with safe management system 1300 and to process that data, as needed, for subsequent storage and use by safe management system 1300.

Notifications subsystem 1304 is configured to maintain and execute notification policies. For purposes of this disclosure, the term “notification” is intended to refer to any communication sent to or otherwise received by a safe or computing device associated with a safe or safe management system 1300 using any suitable communication modality. Accordingly, a notification policy dictates when notifications are generated, where notifications are sent, content of notifications, and the like. For example, a notification policy may dictate that, in response to receiving data from a safe indicating likely tampering (e.g., a high measurement from an accelerometer of the safe), notifications subsystem 1304 is to generate and transmit a notification to each user associated with the safe. A similar notification may be sent in response to one or more failed attempts to access the safe. As another example, a guest may check out of an accommodation using a safe (e.g., using a checkout process presented on a screen of the safe) and the safe may transmit a corresponding checkout indicator to safe management system 1300. In response to receiving the checkout indicator, notifications subsystem 1304 may generate and transmit a notification to an owner of the accommodation to communicate that checkout has occurred.

More generally, notifications subsystem 1304 provides functionality related to generating and transmitting notifications in response to events at one or more safes. Provided a user has sufficient permissions, the user may customize the conditions under which notifications are sent, where notifications are sent, and the like. Among other modalities, this disclosure contemplates that notifications may be in the form of in-app messages, text messages, email messages, voice or voicemail messages, and the like. This disclosure also contemplates that a notification may be sent to a device (e.g., an IoT device) accessible by safe management system 1300 with the notification changing a state of the device. For example, the device may be a light, display, screen, speaker, etc., configured to receive notifications from safe management system 1300 and to produce a corresponding output (e.g., a visual output in the form of a light or message or an audio output in the form of an alert, chime, voice clip, etc.).

Analytics and reporting subsystem 1306 is configured to generate reports, statistics, and facilitate analysis of the substantial data collected by safe management system 1300. Analytics and reporting subsystem 1306 may provide tools and processes for accessing, summarizing, and organizing the data collected by safe management system 1300. Analytics and reporting subsystem 1306 may include features and functionality for automatically generating reports and transmitting generated reports to one or more users of safe management system 1300. To facilitate such reporting, analytics and reporting subsystem 1306 may include various predefined, customer, or user-created report templates or similar forms and tools and features for modifying, creating, and deleting templates.

Analytics and reporting subsystem 1306 may also coordinate distribution of reports based on predefined or custom reporting policies. Each reporting policy may provide the type of report to be provided, the range of data to include in the report, the recipients of the report, and similar parameters for generation and distribution of reports. By way of non-limiting example, analytics and reporting subsystem 1306 may be configured to generate and transmit a report related to safe usage (e.g., as determined by how frequently a set of safes is opened/closed or otherwise accessed) over a recurring period of time. Among other things, such reports may be useful in determining usage of the associated accommodations. As another example, analytics and reporting subsystem 1306 may be configured to generate and transmit a report summarizing failed access attempts, tampering alerts, and similar issues and trends for such issues over time. Such a report may be provided, e.g., to security personnel or management of an accommodation to assess general security of the accommodation. As yet another example, analytics and reporting subsystem 1306 may generate a report summarizing power or network outages for safes of a certain property. Such a report may be provided to and useful for maintenance and/or information technology (IT) personnel associated with the property to identify and diagnose potential infrastructure issues with the property.

As illustrated by the foregoing examples, analytics and reporting subsystem 1306 may be useful in analyzing data specifically related to use and operation safes. However, this disclosure contemplates that the data collected by safe management system 1300 can provide a substantially broader range of insights. For example, the previous examples include uses of data collected from safes and security devices that provide business—(e.g., safe usage as a proxy for occupancy and accommodation usage), security-, and maintenance-related insights.

Safe update subsystem 1308 is configured to update and maintain software and firmware for safes associated with safe management system 1300. For example, in certain implementations, safe update subsystem 1308 maintains a copy of one or more versions of safe software/firmware and obtains and monitors version data collected and maintained in safe data source 1318. In response to identifying that a safe's software/firmware is out of date, safe update subsystem 1308 may automatically initiate an update to the safe, e.g., by transmitting an executable firmware update package to the safe. When received by the safe, the executable firmware update may automatically cause the safe to update its software/firmware, reboot, or take any other necessary steps to implement the update.

As an alternative to the foregoing “push” of software/firmware updates, safe update subsystem 1308 may operate in conjunction with notifications subsystem 1304 to notify a safe owner that a software/firmware update is available. The owner may then respond accordingly, e.g., by initiating download and installation of the update at the safe, by initiating download and installation remotely, by cancelling/rejecting the update, etc.

In at least certain implementations, safe update subsystem 1308 may be configured to provide over-the-air (OTA) updates to safes and corresponding computing devices. While certain OTA updates may be directed to updating or patching existing software/firmware, this disclosure also contemplates that OTA updates may be used to add and configure new features for safes. Such deployment may be in response to various situations. For example, an OTA update may be deployed in response to a new feature being launched. Such an update may be broadly deployed to multiple safes managed by or otherwise in communication with safe management system 1300. As another non-limiting example, safe management system 1300 may deploy an OTA update in response to a user changing a subscription or account level. In such cases, the OTA update may only be deployed to safes associated with the user. This disclosure contemplates that an OTA update may include a deployable package that installs a new feature on a safe. Alternatively, an OTA update may correspond to a command sent to a safe to unlock or otherwise modify a feature already installed on the safe. Similarly, an OTA update may be used to uninstall or restrict features of a safe, e.g., in response to a user changing to a lower tier subscription or service having fewer features and functions.

Communications subsystem 1310 is intended to facilitate communication by safe management system 1300 using a variety of modalities. For example, with respect to communication between safe management system 1300, this disclosure contemplates that communication may occur over a computer network, such as the Internet or similar large-scale network, but may also occur within a private or local network, with communication over such networks occurring using any suitable wired or wireless communication protocol. Depending on the specific configuration of safe management system 1300, it may also support short range communication protocols, such as, but not limited to Bluetooth. This disclosure also contemplates that safe management system 1300 may communicate, at least in part, via email, in-app messaging, social media-based messaging, push notifications, SMS or text messaging, phone calls (including automated phone calls), and the like with communications subsystem 1310 including the necessary components for facilitating such communications.

Administrator portal subsystem 1312 hosts or otherwise provides a portal for users of safe management system 1300. Implementations of the portal may vary, however, in certain implementations, the portal may be used to access historical data, current status, and related analyses on safes associated with the user (or an organization of the user) and, in certain implementations, to facilitate remote operation of specific safes.

With respect to historical data, the portal provided by administrator portal subsystem 1312 may permit a user with suitable permissions to view graphical, tabular, or similar presentations of historical data collected by or in conjunction with operation of one or more safes.

The portal may be configured to allow a user to search, filter, rank, group, drill-down or perform any other similar manipulation of the data of interest. For example, the user may be able to view data corresponding to a time period, a geographic regions, a property type (e.g., a hotel brand), a user (e.g., a specific guest of an accommodation), and the like.

This disclosure further contemplates that the portal may permit a user to review and analyze data based on safe characteristics and/or activity. For example, the portal may allow a user to filter based on a safe model, safe age, safe usage (e.g., safes that are accessed more than once daily), or safes with recent or outstanding critical issues (e.g., loss of power, loss of connectivity). In at least some implementations, the portal may include a notifications section that may include, among other things, a list of errors, alerts, alarms, or similar critical events for safes associated with the user.

In addition to viewing data on a broad scale, the portal may also allow a user to drill-down into a group of safes or an individual safe to obtain specific historical data and information regarding the safe. For example, a user may select a specific safe and be presented with a screen including, without limitation, identifying information for the safe, a location and/or sublocation of the safe, a model of the safe, a current status of the safe (e.g., power on, connected, closed, locked, etc.), a graph of safe usage, a history of critical safe events (e.g., tampering attempts), authentication/access methods supported and active for the safe, current users of a safe, and other similar information. As noted, the portal may also allow a user to select a group of safes and obtain similar information for the group. So, for example, a user may select a group of safes corresponding to a floor of a hotel and be presented with corresponding data for the floor. Among other use cases, such data may be useful in identifying recurrent suspicious activity by a staff member assigned duties (e.g., housekeeping) for the particular floor.

In certain implementations, the portal may also permit access and presentation of user-and account-related data. For example, the portal may provide information regarding which guests accessed a particular safe, the activity of a specific guests or guests with common characteristics, the presence and status of any safe-related subscriptions, etc. For a specific user, the portal may present the user's name, contact information, other personal information, any safes for which the user is an active user, and any similar information. In certain implementations, the portal may also permit a portal user to add remove/modify existing users, change a user's password, reset a user's access (e.g., following a user being locked out from a safe after a certain number of failed access attempts), modify a user's permissions, specify conditions for the user's access (e.g., set a specific time period (e.g., corresponding to a reservation period) or recurring time window (e.g., corresponding to a user's shift) for access by the user), assigns users to particular user groups, and perform other similar administrative functions.

As previously noted, certain implementations of a portal may allow a portal user to transmit commands and control functions of a particular safe. For example, in certain instances, a portal user may be able to remotely unlock or open a safe or, conversely, lock down a safe and prevent all access. The portal may also enable the portal user to enable one or more audio and/or visual systems of the safe. For example, a portal user may activate a speaker and microphone or video system of the safe to communicate with anybody in the area of the safe. The portal user may also cause the safe to take a picture, begin recording audio, begin recording video, or perform any other similar function. As another example, a portal user may also request or otherwise obtain data from one or more onboard sensor of a safe. For example, the portal user may request a temperature or humidity sensor reading for the interior of a safe with such sensors. As yet another example, a portal user may push updates to a safe if the safe is running outdated software or firmware.

The foregoing are just examples of features and functionality that may be provided through the portal presented by administrator portal subsystem 1312. More generally, administrator portal subsystem 1312 is intended to provide an interface through which appropriate users may access and analyzed any data relevant to management and operation of safes. The portal may include any suitable visual elements (e.g., color coded status indicators, heat maps, automatically formatted tables, etc.) to enhance the interface and more effectively communicate information to the portal user. As noted above, the portal may also or alternatively enable remote access, operation, and management of safe functionality.

This disclosure contemplates that at least some functions of safe management system 1300 may be performed using or supported by various algorithms, such as neural networks, large language models, and similar artificial intelligence (AI) models and algorithms. Accordingly, safe management system 1300 is shown in FIG. 13 as including a modelling and Al subsystem. For conciseness, this subsystem is referred to as AI subsystem 1315 in the following discussion. Among other things, modelling and AI subsystem 1315 may include models for use by safe management system 1300, modules and processes for training and updating models of AI subsystem 1315, historical versions of models of AI subsystem 1315, and the like. In at least certain implementations, models stored, maintained, and updated by AI subsystem 1315 may be distributed to other computing systems and safes. Accordingly, AI subsystem 1315 may also facilitate distribution of models to other systems and related version management functions associated with such distributions.

This disclosure contemplates that safe management system 1300 may maintain models and algorithms on a user or safe-specific scale, on a global scale applicable to all safes managed by safe management system 1300, or any scale therebetween. For example, safe management system 1300 may maintain a first set of models related to residential applications or individual users, a second set of models related to accommodation-related (e.g., hotel or dormitory) applications, and a third set of models related to business or other non-accommodation applications.

In one example, modelling/AI subsystem 1315 may include one or more models related to monitoring safe activity. For example, such models may be configured to receive safe activity data as input and to output a risk level, an alert/alarm, or similar indicator related to a status of a given safe. Safe management system 1300 may be further configured to generate notifications, alarms, etc. in response to the output of the one or more models.

In implementations in which AI subsystem 1315 includes safe activity-related models, AI subsystem 1315 may rely on historical data (e.g., as stored in historical data source 1316) to train and update the models. For example, historical data source 1316 may include activity data collected by safes, log entries related to alerts and alarms, and whether the alerts and alarms corresponded to actual security concerns or false alarms. Such data may then be used to train the one or more models such that the one or more models may receive subsequent activity data and determine whether the activity data indicates a likely security concern.

In another example, modelling/AI subsystem 1315 may include one or more models related to biometric analysis. So, for example, AI subsystem 1315 may include one or more facial recognition, voice recognition, fingerprint recognition or similar algorithms for more accurately authenticating users. More specifically, the one or more models may receive biometric data (e.g., a facial image, fingerprint image, voice sample, etc.) and output a metric indicating whether the biometric data corresponds to an authorized user. As with the activity-related models, the biometric models of AI subsystem 1315 may be subject to regular updating and training as additional biometric data for a given user is collected and verified (e.g., using a secondary authentication process).

In yet another example, modelling/AI subsystem 1315 may include one or more models related to image processing and may be used to process and analyze images and video captured by cameras of a safe. For example, as previously discussed, safes according to this disclosure may include an external camera configured to capture images and/or video of an area in front of the safe. Accordingly, AI subsystem 1315 may include one or more models to analyze captured images and video including, but not limited to, identifying people and items within the vicinity of the safe. As another example, image processing models may also be used in conjunction with internal cameras of safes according to this disclosure. For example, AI subsystem 1315 may include one or more models configured to analyze images of the internal contents of safes and to determine whether an object is within the safe and, in certain implementations, to identify objects within the safe.

In either case, image processing models of AI subsystem 1315 may trained, at least in part, using feedback provided by safe users. For example, safe management system 1300 may request that a user tag or otherwise identify objects captured by cameras of a safe associated with the user. The AI subsystem 1315 may then use the image data and associated tagging information to train and improve its image processing algorithms.

While the foregoing discussion focuses on models and algorithms managed by safe management system 1300, this disclosure also contemplates that similar models may be stored and executed by a safe itself. In such implementations, the models may be stored and maintained locally by a particular safe. Such models may be static or may be periodically updated. This disclosure contemplates that updating and training of safe-stored models may include training and updating the models based on data collected by the safe storing the model or by receiving remote updates from safe management system 1300.

While certain advantages and enhancements of safes and safe management systems according to this disclosure are discussed in detail, above, this section of the disclosure provides a specific example of how safes according to this disclosure may provide additional functionality that is beyond conventional safes and that is specifically facilitated by the various concepts discussed in this disclosure.

Guests leaving valuables and important items behind in a safe at an accommodation is a common occurrence. At best, having to return to an accommodation following checkout to retrieve valuables is an inconvenience. However, the consequences of leaving items in a safe can be substantially more problematic in certain situations. For example, a traveler that leaves his or her passport in a hotel safe only to realize their mistake at a later time while passing through customs can have his or her entire trip upended. Similarly, a guest may only realize at a later time that he or she left medication behind in a safe only when an acute health problem requiring the medication arises. With this particular problem in mind, safes and safe management systems according to this disclosure provide efficient and effective ways in which a guest can be reminded of items left within a safe when checking out of an accommodation.

Notably, while the foregoing discussion and following method are generally described in the context of leaving an item in a safe associated with an accommodation, it should be understood that use of the term “accommodation” is non-limiting and that the concept of automatic notifications of items left in a safe may be adapted for other use cases. Stated differently, the concept of automatic notifications may be readily adapted to notify users of items left in safes and similar containers (e.g., lockboxes, lockers, etc.) regardless of whether those containers are associated with a conventional accommodation. Accordingly, while the following discussion refers to a guest of an accommodation and checking safe contents in response to the guest checking out of the accommodation, this disclosure contemplates that the disclosed method may be readily adapted to a more general case of a user of a safe leaving a premise including the safe or otherwise ending use of the safe. So, for example, the safe may be a locker at a gym and the “check-out” may correspond to the user performing some action related to leaving the gym premises (e.g., badging or swiping out of the gym facility).

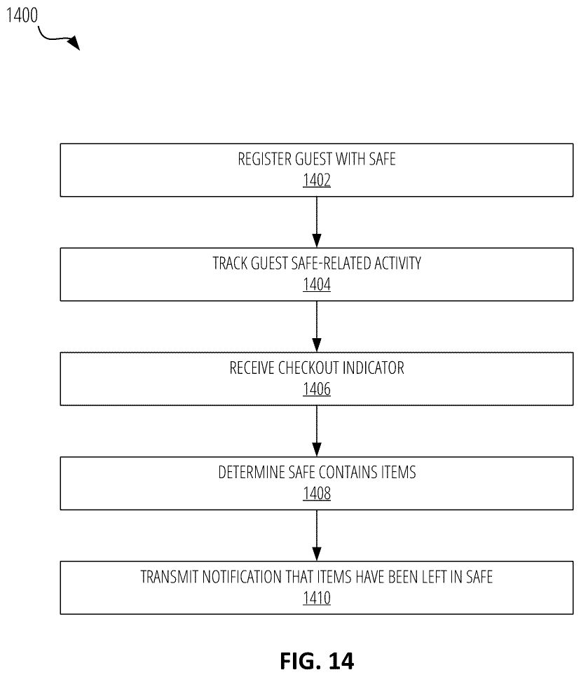

FIG. 14 is a flow chart illustrating a method 1400 for automatically generating reminders regarding items left within a safe. While the discussion below specifically refers to a guest in a hotel, one of skill in the art could readily adapt the following description to other applications.

Beginning at step 1402, the guest optionally registers as a user for a safe within the room the guest is occupying. In certain implementations, the user may register as part of a check-in process with the hotel. In such cases, a hospitality management system of the hotel may be in communication with a safe management system, similar to the enterprise system 1134 and safe management system 1102 of FIG. 11B and may communicate details regarding the guest and the guest's stay to the safe management system. Among other things, the guest details may include the guest's name and contact information while the information regarding the guest's stay may include the room in which the guest is staying and the duration of the stay. In response to receiving this information from the hospitality management system, the safe management system may create a user within the safe management system corresponding to the guest and assign time-limited permissions to the guest to access the safe during the guest's stay.

In other implementations, the guest may register as a user of the safe using a suitable computing device. For example, in certain implementations, the guest may execute a safe-related application on his or her personal computing device (e.g., a smartphone, laptop, tablet, etc.) that proceeds to associate the guest with the safe for the duration of the guest's stay. Alternatively, the guest may register using the safe itself.

The registration process may be streamlined based on prior interactions between the guest and safes managed by the safe management system. For example, a guest may have used a safe previously and provided personal and contact information and authentication data (e.g., voice data, fingerprint data, a passcode, etc.) that was stored and maintained by the safe management system in conjunction with the prior use. In such cases, the safe management system may provide the guest's information to the safe as part of an initial configuration and registration process once confirming the identify to the guest. Alternatively, the guest's information (including authentication data) may be stored on the guest's personal computing device and sent to the safe during configuration and registration using a suitable application.

At step 1404, the safe tracks activity of the guest with respect to the safe. Tracking activity may include measuring and logging sensor data measured by any of the various subsystems that may be included in the safe. For example, tracking activity of the guest may include logging when the guest opens or closes the safe, capturing recordings or images of the environment around the safe or safe internals, identifying and logging changes in sensor measurements of the safe, identifying and logging changes in the state of components of the safe (e.g., an device being plugged into or removed from an internal plug of the safe), and the like.

In certain implementations, the tracking data collected by the safe may be stored and maintained at the safe. Alternatively, the safe may be configured to provide collected data in real-time or periodically to a remote computing system, such as the hospitality management system or the safe management system.

At step 1406, a checkout indicator is received within the broader safe system. The checkout indicator may be received by various devices within the safe system. For example, in one case, the checkout indicator may be generated by the hospitality management system, e.g., in response to the guest checking out at a front desk of the hotel, and subsequently transmitted to the safe management system. As another example, the checkout indicator may be generated in response to the guest communicating that he or she is checking out of the accommodation through an application executed on a personal device of the guest and in communication with either the safe or the safe management system. The guest may also communicate the intention to check out through the computing device of the safe itself. As yet another example, the checkout indicator may be automatically generated in response to the guest's accommodation period approaching its end (e.g., as provided during the registration process of step 1402).

Regardless of where the guest's original intention to check out is received, a corresponding message or indicator may be transmitted to the safe management system, which then initiates a process to determine whether the safe contains or is likely to still contain items at step 1408.

The process of determining whether items have been left in the safe can vary. In one example implementation, the safe management system may submit a request to the safe for sensor data that may indicate the presence of an item within the safe. For example, the safe may include a weight plate configured to measure the weight of contents within the safe. Accordingly, if the measurement from the weight plate exceeds a threshold, the safe management system may determine that an item is still within the safe. Other sensors that may provide similar information include magnetic sensors (e.g., for detecting the presence of electronic devices) and optical sensors. The safe may also include a sensor corresponding to an internal port of the safe and configured to measure whether a device is currently plugged into the port.

As another example, the safe management system may access and analyze historical data for the safe to assess the likelihood that the guest already retrieved their items. In one specific implementation, the safe management system may first determine whether the guest accessed the safe at any point during his or her stay. If so, the safe management system may determine if the guest accessed the safe within a particular time period (e.g., one hour) prior to receipt of the checkout indicator, strongly implying that the guest retrieved his or her items.

As yet another example, the safe management system may request that the safe obtain and provide an internal photograph of the safe. The safe management system may then analyze the photograph (e.g., by comparing the photograph to a photograph of the safe when empty) to determine whether anything is in the safe.

To the extent the safe management system determines an item is in the safe, the safe management system may transmit a suitable notification at step 1410. In certain implementations, the notification is transmitted to the guest using a suitable method. For example, the safe management system may have contact information (e.g., phone number, email address, etc.) for the guest and may transmit a notification using the contact information (e.g., a text message, push notification, automated phone call, etc.). Similarly, the safe management system may transmit a notification (e.g., a push notification or in-app notification) to the guest via an application executed on a personal computing device of the guest.

As another example, the safe management system may transmit a notification that items have been left in the safe to the hospitality management system, particularly if the checkout indicator in step 1406 was received via the hospitality management system. A user of the hospitality system may then contact the guest accordingly. In certain implementations, the user of the hospitality system may contact the guest directly. Alternatively, the user of the hospitality system may transmit a notification to the safe management system for handling by another party, such as a customer service operator.

The foregoing process may occur in substantially real-time, limiting the likelihood that a guest will leave an item within the safe and avoiding many of the potential issues and pitfalls noted at the outset of this section.

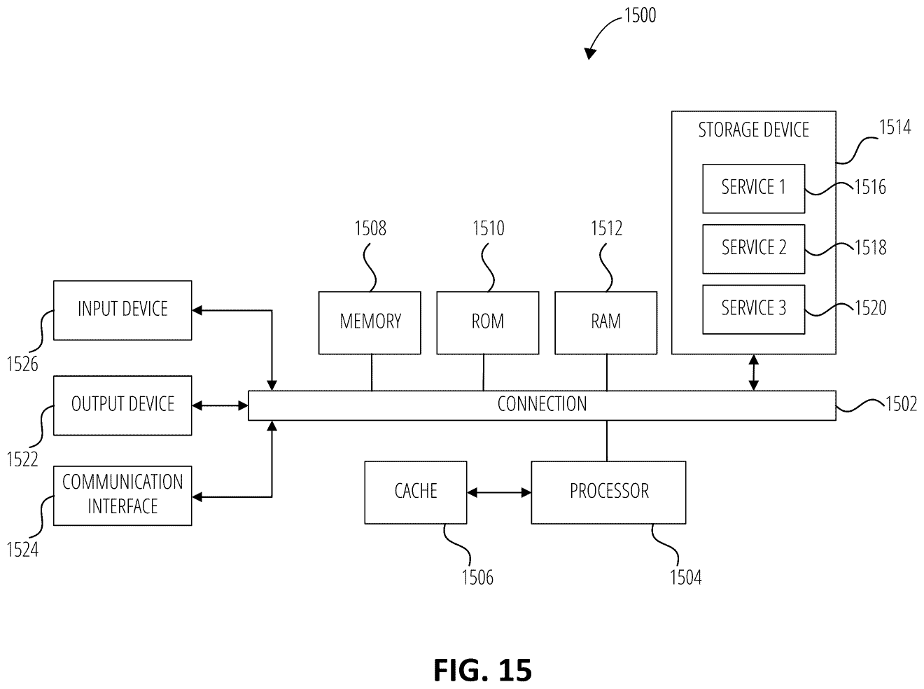

FIG. 15 shows an example of computer system 1500, which can be for example any computing device making up a safe, computing device, computing system, or any component thereof in which the components of the system are in communication with each other using connection 1502. Connection 1502 can be a physical connection via a bus, or a direct connection into processor 1504, such as in a chipset architecture. Connection 1502 can also be a virtual connection, networked connection, or logical connection.

In some embodiments, computer system 1500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computer system 1500 includes at least one processing unit (CPU or processor 1504) and connection 1502 that couples various system components including system memory 1508, such as read-only memory (ROM) 1510 and random-access memory (RAM) 1512 to processor 1504. Computer system 1500 can include a cache 1506 of high-speed memory connected directly with, in close proximity to, or integrated as part of processor 1504.

Processor 1504 can include any general-purpose processor and a hardware service or software service, such as services 1516, 1518, and 1520 stored in storage device 1514, configured to control processor 1504 as well as a special-purpose processor where software instructions are incorporated into the actual processor design. Processor 1504 may essentially be a completely self-contained computing system, containing multiple cores or processors, a bus, memory controller, cache, etc. A multi-core processor may be symmetric or asymmetric.

To enable user interaction, computer system 1500 includes an input device 1526, which can represent any number of input mechanisms, such as a microphone for speech, a touch-sensitive screen for gesture or graphical input, keyboard, mouse, motion input, speech, etc. Computer system 1500 can also include output device 1522, which can be one or more of a number of output mechanisms known to those of skill in the art. In some instances, multimodal systems can enable a user to provide multiple types of input/output to communicate with computer system 1500. Computer system 1500 can include communication interface 1524, which can generally govern and manage the user input and system output. There is no restriction on operating on any particular hardware arrangement, and therefore the basic features here may easily be substituted for improved hardware or firmware arrangements as they are developed.

Storage device 1514 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Storage device 1514 can include software services, servers, services, etc., that when the code that defines such software is executed by the processor 1504, it causes the system to perform a function. In some embodiments, a hardware service that performs a particular function can include the software component stored in a computer-readable medium in connection with the necessary hardware components, such as processor 1504, connection 1502, output device 1522, etc., to conduct the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that conduct a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A safe comprising:
a compartment assembly defining a safe volume;
a door assembly coupled to a front of the compartment assembly;
a sensor for measuring safe-related events; and
a computing system communicatively coupled to the sensor, wherein the computing system is configured to:
receive sensor data from the sensor,
transmit the sensor data to a safe management system remote from the safe for storage as historical data, and
transmit supplemental sensor data to the safe management system in response to a request for supplemental sensor data received from the safe management system following receipt of a checkout indicator for an accommodation at the safe management system.

2. The safe of claim 1 further comprising an internal camera assembly disposed within the safe volume and configured to capture images of the safe volume.

3. The safe of claim 1, wherein the door assembly further includes an external camera assembly configured to capture images in front of the door assembly.

4. The safe of claim 1 further comprising a biometric access device.

5. The safe of claim 4, wherein the biometric access device is a fingerprint scanner in communication with the computing system.

6. The safe of claim 1, wherein the door assembly further includes a fingerprint scanner in communication with the computing system.

7. The safe of claim 1 further comprising a tamper sensor configured to measure movement of the safe and in communication with the computing system, wherein the computing system is configured to transmit an alert message in response to a measurement generated by the tamper sensor.

8. The safe of claim 1, further comprising an accelerometer configured to measure movement of the safe and in communication with the computing system, wherein the computing system is configured to transmit an alert message in response to a measurement generated by the accelerometer.

9. The safe of claim 1, wherein the door assembly includes a touchscreen.

10. A computer-implemented method comprising:
receiving, at a safe management system, an indicator corresponding to a user of a safe leaving a premises of the safe;
accessing historical data corresponding to the safe, the historical data including events detected by the safe and transmitted by the safe to the safe management system; and
transmitting a message in response to the historical data, wherein, when received by a computing device, the message causes the computing device to present a reminder notification indicating that the safe was in use during a time period.

11. The computer-implemented method of claim 10, wherein the computing device is a user computing device associated with the user.

12. The computer-implemented method of claim 10, wherein the computing device is a user computing device associated with the user and the indicator is received from the user computing device.

13. The computer-implemented method of claim 10, wherein the computing device is a user computing device associated with the user and the indicator is received from the safe.

14. The computer-implemented method of claim 10, wherein the computing device is a user computing device associated with the user linked and the indicator is received from a computing system associated with the premises.

15. The computer-implemented method of claim 10, wherein:
the computing device is part of a hospitality management system configured to administer an accommodation, and
the indicator is a check-out indicator received from a user computing device associated with the user.

16. The computer-implemented method of claim 10, wherein:
the computing device is associated with a hospitality management system, and
the indicator is a check-out indicator received from the computing device.

17. The computer-implemented method of claim 10, wherein the historical data includes log data corresponding to at least one of:
a safe opening event;
a safe closing event;
a safe open duration;
a safe closed duration;
a safe access attempt event;
a successful safe access event;
a failed safe access event;
a safe lockdown event;
a change to users of a safe; and
use of emergency functionality of a safe.
